(19) United States
(12) Patent Application Publication
(10) Pub. No.: US 2025/0336581 A1
(43) Pub. Date: Oct. 30, 2025

(54) SOFT MAGNETIC POWDER, MAGNETIC CORE, AND MAGNETIC DEVICE

(71) Applicant: TDK Corporation, Tokyo (JP)

(72) Inventors: Masakazu HOSONO, Tokyo (JP); Kazuhiro YOSHIDOME, Tokyo (JP); Satoko MORI, Tokyo (JP)

(73) Assignee: TDK Corporation, Tokyo (JP)

(21) Appl. No.: 19/040,043

(22) Filed: Jan. 29, 2025

(30) Foreign Application Priority Data
Apr. 26, 2024 (JP) 2024-072682

(51) Int. Cl. H01F 1/147; B22F 1/054; C22C 38/00; C22C 38/10; H01F 3/08; H01F 41/02

(52) U.S. Cl. CPC H01F 1/147; B22F 1/056; C22C 38/002; C22C 38/10; H01F 3/08; B22F 2301/35; H01F 41/0246

(57) ABSTRACT

A soft magnetic powder contains Fe and C. The soft magnetic powder has a C content of 0.01 mass % or more and 0.5 mass % or less. The soft magnetic powder includes a specific soft magnetic particle. The specific soft magnetic particle includes both a phase having a symmetry of a space group Im-3m or Pm-3m and a phase having a symmetry of a space group Pnam.

### BACKGROUND OF THE INVENTION

The present invention relates to a soft magnetic powder, a magnetic core, and a magnetic device.

### BACKGROUND

Magnetic devices, such as inductors, require high DC superimposition characteristics. This is because, in a situation where the magnetic devices are included in power supply devices, such as DC-DC converters, the magnetic devices need to maintain high inductance even if a direct current is superimposed on the magnetic devices.

Patent Document 1 describes an invention related to a soft magnetic material that contains at least 90 mass % Fe and Co in total and is characterized in that the soft magnetic material contains a precipitate of a compound of iron and nitrogen.

### PRIOR ARTS

### Patent Document

[Patent Document 1] WO2022-070508

### BRIEF SUMMARY OF THE INVENTION

### Problem to be Solved by Invention

It is an object of the present invention to provide a soft magnetic powder that enables a magnetic core and a magnetic device having high DC superimposition characteristics to be provided.

### Means for Solving the Problem

A soft magnetic powder according to the present invention is a soft magnetic powder containing Fe and C, wherein
the soft magnetic powder has a C content of 0.01 mass % or more and 0.5 mass % or less;
the soft magnetic powder includes a specific soft magnetic particle; and
the specific soft magnetic particle includes both a phase having a symmetry of a space group Im-3m or Pm-3m and a phase having a symmetry of a space group Pnam.

The soft magnetic powder may further contain Co; and

the soft magnetic powder may have a ratio of an Fe content to a total content of Fe and Co of 25 mass % or more and 99 mass % or less.

The phase having the symmetry of the space group Im-3m or Pm-3m may include an (Fe, Co) phase; and

the phase having the symmetry of the space group Pnam may include an (Fe, Co)₃C phase.

The specific soft magnetic particle including specific soft magnetic particles may account for a number ratio of 10% or more.

Soft magnetic particles included in the soft magnetic powder may have an average particle size of 0.1 μm or more and 50 μm or less.

The soft magnetic powder may further contain a subcomponent; and

the soft magnetic powder may have a content of the subcomponent of 15 mass % or less out of 100 mass % of the soft magnetic powder.

The subcomponent may include at least one selected from the group consisting of B, Si, P, Cu, V, Ti, Zr, Hf, Nb, Ta, Mo, W, Cr, Ni, Al, Mn, Ag, Zn, S, Sn, As, Sb, Bi, N, O, and a rare earth element.

A magnetic core of the present invention includes the above soft magnetic powder.

A magnetic device of the present invention includes the above soft magnetic powder.

### BRIEF DESCRIPTION OF THE SEVERAL VIEWS OF THE DRAWING

FIG. 1 is a bright field image obtained by observing a section of a soft magnetic powder including specific soft magnetic particles using a STEM.

FIG. 2 is an electron diffraction image obtained by capturing a soft magnetic particle 1 of FIG. 1 using a selected-area diffraction method.

FIG. 3 is an electron diffraction image obtained by capturing a soft magnetic particle 2 of FIG. 1 using the selected-area diffraction method.

FIG. 4 is an electron diffraction image obtained by capturing a soft magnetic particle 3 of FIG. 1 using the selected-area diffraction method.

FIG. 5 is an electron diffraction image obtained by capturing a soft magnetic particle that is not a specific soft magnetic particle using the selected-area diffraction method.

### DETAILED DESCRIPTION OF THE INVENTION

### Description of Embodiment

Hereinafter, the present invention is described with reference to an embodiment.

### (Composition of Soft Magnetic Powder)

A soft magnetic powder contains Fe and C. The soft magnetic powder has a C content of 0.01 mass % or more and 0.5 mass % or less. The soft magnetic powder may further contain Co. The ratio of the Fe content to the total content of Fe and Co may be 25 mass % or more and 99 mass % or less.

In a situation where the C content of the soft magnetic powder is too low, it is difficult for the soft magnetic powder to include specific soft magnetic particles described later, readily decreasing DC superimposition characteristics of a magnetic core. In a situation where the C content of the soft magnetic powder is too high, the soft magnetic powder readily includes, together with more specific soft magnetic particles described later, more soft magnetic particles including only a phase having a symmetry of a space group Pnam and not including a phase having a symmetry of a space group Im-3m or Pm-3m. Thus, saturation magnetization of the soft magnetic powder is readily decreased, and DC superimposition characteristics of a magnetic core are readily decreased.

The ratio of the Fe content to the total content of Fe and Co being 25 mass % or more enables DC superimposition characteristics of a magnetic core including the soft magnetic powder to be readily improved. The ratio of the Fe content to the total content of Fe and Co being 99 mass % or less enables the soft magnetic powder to readily have suitably balanced coercivity, saturation magnetic flux density, and corrosion resistance.

The soft magnetic powder includes soft magnetic particles. The soft magnetic particles included in the soft magnetic powder may have an average particle size of 0.1 μm or more and 50 μm or less. The average particle size being 0.1 μm or more enables the magnetic core to readily have an improved packing rate and improved relative permeability. The average particle size being 50 μm or less makes it difficult for eddy current loss of the magnetic core to increase.

Methods of measuring the average particle size of the soft magnetic particles are not limited. For example, a field of view of a STEM may be determined so that at least 20000 soft magnetic particles in their entirety are included in the field of view to observe sections of the soft magnetic particles, and an average of equivalent circle diameters of these soft magnetic particles may be deemed to be the average particle size of the soft magnetic particles. One field of view including the at least 20000 soft magnetic particles in their entirety may be observed, or a plurality of fields of view including the at least 20000 soft magnetic particles in their entirety in total may be observed. An equivalent circle diameter of a soft magnetic particle is a diameter of a circle having an area equivalent to the sectional area of the soft magnetic particle.

The soft magnetic powder according to the present embodiment may further contain a subcomponent other than Fe, Co, and C. The subcomponent may include, for example, at least one selected from the group consisting of B, Si, P, Cu, V, Ti, Zr, Hf, Nb, Ta, Mo, W, Cr, Ni, Al, Mn, Ag, Zn, S, Sn, As, Sb, Bi, N, O, and a rare earth element. Rare earth elements include Sc, Y, and lanthanides.

The above subcomponent being contained in the soft magnetic powder enables relative permeability or eddy current loss of the magnetic core manufactured using the soft magnetic powder to be readily controlled. The above subcomponent content may be 25 mass % or less in total, 15 mass % or less in total, or 5 mass % or less in total. The subcomponent content being within the above range enables saturation magnetization of the soft magnetic powder to be readily improved.

The soft magnetic powder may contain, as inevitable impurity, elements other than the above elements, i.e., elements other than the elements included in the group consisting of Fe, Co, C, B, Si, P, Cu, V, Ti, Zr, Hf, Nb, Ta, Mo, W, Cr, Ni, Al, Mn, Ag, Zn, S, Sn, As, Sb, Bi, N, O, and a rare earth element. The inevitable impurity content is not limited; however, out of 100 mass % soft magnetic powder as a whole, the inevitable impurity content may be 1 mass % or less in total.

The total content of the subcomponent and the inevitable impurity of the soft magnetic powder may be 26 mass % or less, 16 mass % or less, or 6 mass % or less. That is, the total content of Fe, Co, and C may be 74 mass % or more, 84 mass % or more, or 94 mass % or more.

### (Specific Soft Magnetic Particle)

The soft magnetic powder according to the present embodiment includes the soft magnetic particles. The soft magnetic particles are classified under the specific soft magnetic particles and other soft magnetic particles.

The soft magnetic powder according to the present embodiment includes the specific soft magnetic particles. The specific soft magnetic particles denote soft magnetic particles including both a phase having the symmetry of the space group Im-3m or Pm-3m and a phase having the symmetry of the space group Pnam.

Moreover, the specific soft magnetic particles of the soft magnetic powder may account for a number ratio of 10% or more. There is no upper limit of the number ratio of the specific soft magnetic particles of the soft magnetic powder. The number ratio of the specific soft magnetic particles of the soft magnetic powder may be, for example, 100% or less. That is, all the soft magnetic particles included in the soft magnetic powder may be the specific soft magnetic particles.

An example method of checking whether the soft magnetic particles are the specific soft magnetic particles is described below.

First, a section of the soft magnetic powder is observed using a STEM (scanning transmission electron microscope). Instead of the STEM, a TEM (transmission electron microscope) may be used. To observe the section of the soft magnetic powder, a sample for sectional observation is prepared. Methods of preparing the sample for sectional observation are not limited. For preparation, the soft magnetic powder and resin may be kneaded, and then the kneaded product may be cut. For preparation, the magnetic core including the soft magnetic powder may be cut.

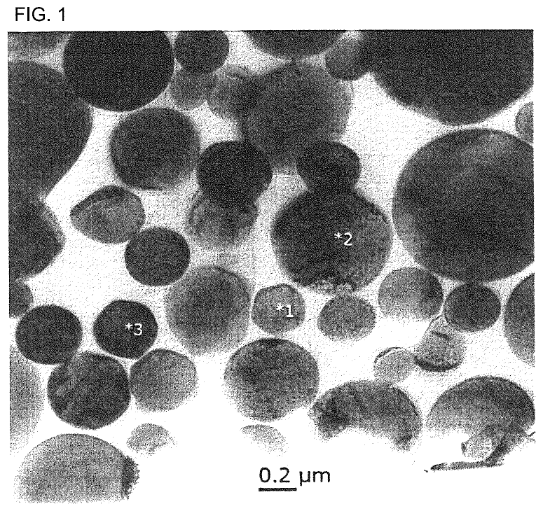

FIG. 1 is a bright field image obtained by observing the section of the soft magnetic powder including the specific soft magnetic particles using the STEM.

Then, electron diffraction images of the soft magnetic particles, which are subject to checking whether they are the specific soft magnetic particles, are captured. Methods of capturing the electron diffraction images are not limited. A selected-area diffraction method may be used to capture the electron diffraction images.

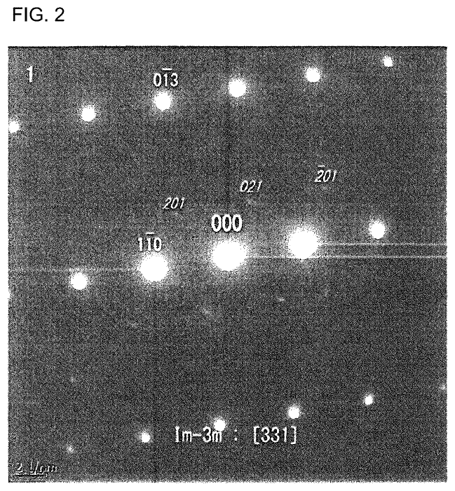

FIG. 2 is an electron diffraction image of a soft magnetic particle 1 of FIG. 1 captured using the selected-area diffraction method.

An intense spot indexed 11-0 in upright font, an intense spot indexed 000 in upright font, and an intense spot indexed 01-3 in upright font in FIG. 2 are diffraction spots attributed to a phase having the symmetry of the space group Im-3m. A weak spot indexed 201 in italic font, a weak spot indexed 021 in italic font, and a weak spot indexed 2-01 in italic font are diffraction spots attributed to a phase having the symmetry of the space group Pnam. Numerals or characters having “−” following them are synonymous with numerals or characters having “−” above them in FIG. 2.

Thus, according to FIG. 2, it is confirmed that the soft magnetic particle 1 of FIG. 1 includes a phase having the symmetry of the space group Im-3m and a phase having the symmetry of the space group Pnam.

From an analysis of the soft magnetic particle 1 using energy dispersive X-ray spectroscopy with STEM-EDS, elements contained in each phase included in the soft magnetic particle 1 can be confirmed. Note that, if all of the soft magnetic particles included in the soft magnetic powder have substantially the same composition, elements contained in each phase included in the soft magnetic particle 1 can be confirmed from the composition of the soft magnetic powder.

A phase having the symmetry of the space group Im-3m may be present as a crystal grain in the specific soft magnetic particles.

From above, that “a soft magnetic particle includes a phase having a symmetry of a specific space group” means that a spot by which the specific space group can be indexed is observed in an electron diffraction image of the soft magnetic particle obtained by capturing it using the selected-area diffraction method.

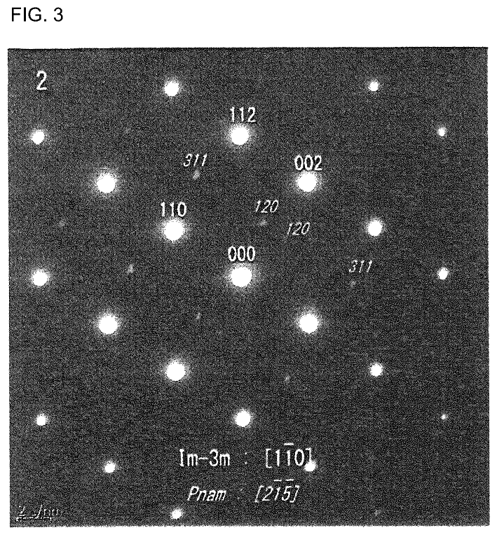

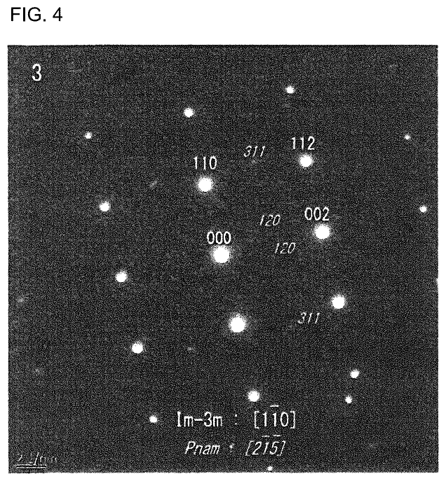

FIG. 3 is an electron diffraction image of a soft magnetic particle 2 of FIG. 1 captured using the selected-area diffraction method. FIG. 4 is an electron diffraction image of a soft magnetic particle 3 of FIG. 1 captured using the selected-area diffraction method.

Similarly to FIG. 2, in the electron diffraction images shown as FIGS. 3 and 4, an intense spot indexed in upright font is a diffraction spot attributed to a phase having the symmetry of the space group Im-3m. A weak spot indexed in italic font is a diffraction spot attributed to a phase having the symmetry of the space group Pnam. Similarly to the soft magnetic particle 1 of FIG. 1, it can be confirmed that the soft magnetic particles 2 and 3 of FIG. 1 are the specific soft magnetic particles.

Spots indexed 000 in FIGS. 2 to 4 are spots generated by transmitted electrons.

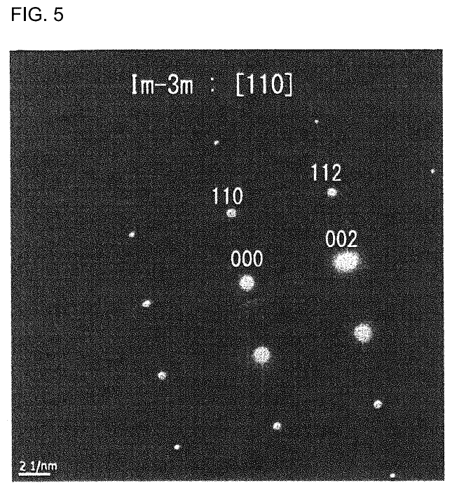

FIG. 5 is an electron diffraction image of a soft magnetic particle that is not a specific soft magnetic particle captured using the selected-area diffraction method. In FIG. 5, intense diffraction spots attributed to a phase having the symmetry of the space group Im-3m are confirmed; however, no weak spot having the symmetry of the space group Pnam is confirmed. Thus, according to FIG. 5, it is confirmed that this soft magnetic particle includes a phase having the symmetry of the space group Im-3m and does not include a phase having the symmetry of the space group Pnam.

The soft magnetic powder including the specific soft magnetic particles can be used for manufacture of a magnetic core having high relative permeability and high DC superimposition characteristics. The specific soft magnetic particles are harder than the other soft magnetic particles. This is because the specific soft magnetic particles include a phase having the symmetry of the space group Pnam. Thus, in a situation where a magnetic core is manufactured using the soft magnetic powder including the specific soft magnetic particles, at the time of manufacture of the magnetic core, deformation of the soft magnetic powder less readily occurs; fluidity of the soft magnetic powder improves; and the soft magnetic powder in the magnetic core is evenly distributed.

From the above reason, in a situation where the soft magnetic powder including the specific soft magnetic particles is used, the magnetic core having high DC superimposition characteristics can be provided.

The above phase having the symmetry of the space group Im-3m may be an (Fe, Co) phase. The above phase having the symmetry of the space group Pnam may be an (Fe, Co)₃C phase.

In a situation where the phase having the symmetry of the space group Im-3m contains Fe and Co, i.e., in a situation where the soft magnetic particle 1 contains Fe and Co, the phase having the symmetry of the space group Im-3m can be identified as an (Fe, Co) phase. Note that the (Fe, Co) phase is a magnetic phase. In a situation where the phase having the symmetry of the space group Pnam contains Fe, Co, and C, i.e., in a situation where the soft magnetic particle 1 contains Fe, Co, and C, the phase having the symmetry of the space group Pnam can be identified as an (Fe, Co)₃C phase. Note that the (Fe, Co)₃C phase is a magnetic phase with lower saturation magnetization than that of the (Fe, Co) phase. It can be confirmed that the soft magnetic particle 1 of FIG. 1 is the specific soft magnetic particle.

An order of Fe and Co contained in the phase having the symmetry of the space group Im-3m may be regularized. In a situation where the order of Fe and Co is regularized, a weak diffraction spot attributed to forbidden reflection appears. The weak diffraction spot attributed to forbidden reflection has the symmetry of the space group Pm-3m. It may be that no diffraction spot attributed to a phase having the symmetry of the space group Im-3m is confirmed and that only a diffraction spot attributed to a phase having the symmetry of the space group Pm-3m is confirmed.

The number ratio of the specific soft magnetic particles of the soft magnetic powder may be 5% or more, 10% or more, or 20% or more. The higher the number ratio of the specific soft magnetic particles, the more readily hardness of the soft magnetic powder is improved, and the more readily the soft magnetic powder is evenly distributed at the time of manufacture of the magnetic core. Thus, DC superimposition characteristics of the magnetic core are readily improved.

### (Method of Manufacturing Soft Magnetic Powder)

A method of manufacturing the soft magnetic powder according to the present embodiment is described; however, methods of manufacturing the soft magnetic powder according to the present embodiment are not limited to the following method.

The soft magnetic powder including the specific soft magnetic particles can be manufactured using, for example, a water+organic solvent atomization method.

A water atomization method is known as a method of manufacturing a soft magnetic powder. In the normal water atomization method, a molten metal in which raw material metals are melted is turned into a powder using high-pressure water to give the soft magnetic powder.

In the water+organic solvent atomization method, water used for turning the molten metal into the powder in the water atomization method is replaced with a liquid (which may hereinafter be referred to as a mixed liquid) in which water and an organic solvent are mixed. That is, in the water+organic solvent atomization method, a molten metal in which raw material metals are melted is turned into a powder using a high-pressure mixed liquid to give the soft magnetic powder.

In the water+organic solvent atomization method, first, a cooling tank into which the molten metal drips is provided with an inert gas atmosphere. As an inert gas, a noble gas, such as nitrogen, Ar, or He, is preferably used. In terms of cost reduction, nitrogen is more preferably used. Then, the molten metal dripped into the cooling tank is turned into the powder using the high-pressure mixed liquid.

The organic solvent included in the mixed liquid is decomposed into carbon dioxide and hydrogen by the molten metal having a high temperature. Carbon dioxide is reduced by hydrogen to generate carbon. A part of generated carbon is incorporated into the molten metal. Consequently, the soft magnetic powder eventually obtained contains carbon even though the molten metal initially does not contain carbon.

The present inventors have found that the soft magnetic powder manufactured with the water+organic solvent atomization method using a molten metal containing Fe readily and suitably includes the specific soft magnetic particles. A reason why the soft magnetic powder manufactured with the water+organic solvent atomization method using the molten metal containing Fe readily includes the specific soft magnetic particles is described below.

In the following description, Fe may be partly replaced with Co. In a situation where Fe is partly replaced with Co, “a phase having the symmetry of the space group Im-3m” may be replaced with “an (Fe, Co) phase”. “A phase having the symmetry of the space group Pnam” may be replaced with “an (Fe, Co)₃C phase”.

In the molten metal having a high temperature, Fe metal phases are present as phases having a symmetry of a space group Fm3m. Thus, gaps between atoms included in the Fe metal phases are relatively large. In the Fe metal phases, a maximum of about 2 mass % carbon can be solid-dissolved.

As the molten metal cools, the phases having the symmetry of the space group Fm3m become phases having the symmetry of the space group Im-3m. Carbon is less readily solid-dissolved in the phases having the symmetry of the space group Im-3m, compared to the phases having the symmetry of the space group Fm3m. Solid-dissolved carbon, together with Fe contained in the soft magnetic powder, form phases having the symmetry of the space group Pnam. Then, the phases having the symmetry of the space group Pnam are deposited between the phases having the symmetry of the space group Im-3m.

A reason why DC superimposition characteristics of the magnetic core are improved when it is manufactured using the soft magnetic powder according to the present embodiment is described below.

Phases having the symmetry of the space group Pnam have a crystal structure including twelve Fe atoms and four C atoms in a unit cell. The Fe atoms and the C atoms are bonded by a strong covalent bond. Thus, the phases having the symmetry of the space group Pnam are extremely hard. In contrast, phases having the symmetry of the space group Im-3m or Pm-3m are relatively soft.

In the specific soft magnetic particles, the phases having the symmetry of the space group Pnam are deposited between the phases having the symmetry of the space group Im-3m or Pm-3m. Thus, the specific soft magnetic particles are soft magnetic particles with both hardness and softness and are less readily broken or deformed. In a situation where the magnetic core is manufactured using the soft magnetic powder including the specific soft magnetic particles, the soft magnetic particles are readily distributed with evenness to improve DC superimposition characteristics of the magnetic core.

Adding carbon to the raw material metals also enables the molten metal to contain carbon. This enables the soft magnetic powder eventually obtained to contain carbon. However, a soft magnetic powder manufactured from a molten metal containing carbon using the water atomization method does not include the specific soft magnetic particles.

In a situation where the soft magnetic powder is manufactured using the water atomization method, carbon is incorporated, as a martensite phase or a retained austenite phase, into the phases having the symmetry of the space group Im-3m; and the phases having the symmetry of the space group Pnam are not deposited. Consequently, if a magnetic core is manufactured using the soft magnetic powder manufactured using the water atomization method, the soft magnetic particles are less readily distributed with sufficient evenness, and DC superimposition characteristics of the magnetic core are not sufficiently increased.

From above, the present inventors have found that a use of the water+organic solvent atomization method for manufacture of the soft magnetic powder can suitably provide the soft magnetic powder including the specific soft magnetic particles.

Types of the organic solvent used for the water+organic solvent atomization method are not limited. Examples of such organic solvents include monohydric alcohol (e.g., methanol or ethanol), dihydric alcohol (e.g., ethylene glycol), trihydric alcohol (e.g., glycerine), and carboxylic acids (e.g., formic acid or acetic acid). In particular, in terms of easiness of handling, cost, or the like, ethanol is preferably used as the organic solvent.

Uses of the magnetic powder according to the present embodiment are not limited. Examples of uses include magnetic devices, such as inductors, transformers, EMI filters, or magnetic heads, included in sensors, stator cores of motors, or the like.

### (Magnetic Core)

A magnetic core according to the present embodiment includes the above soft magnetic powder. The soft magnetic powder may be insulation coated.

The magnetic core according to the present embodiment may include, in addition to the above soft magnetic powder, other powder. The composition and the microstructure of the other powder are not limited. The composition and the microstructure are appropriately selected according to a use or the like of the magnetic core. In a situation where the other powder has an amorphous structure and/or a nanocrystalline structure, the magnetic core readily has improved relative permeability and decreased core loss.

A soft magnetic powder having an average particle size exceeding 3 μm is referred to as a large-size powder. A soft magnetic powder having an average particle size of 3 μm or less is referred to as a small-size powder. The magnetic core according to the present embodiment may be manufactured using only the large-size powder, only the small-size powder, or a powder in which the large-size powder and the small-size powder are mixed. The large-size powder and/or the small-size powder may be insulation coated.

The large-size powder and the small-size powder may include the specific soft magnetic particles; only the large-size powder may include the specific soft magnetic particles; or only the small-size powder may include the specific soft magnetic particles.

In a situation where the magnetic core is manufactured using the powder in which the large-size powder and the small-size powder are mixed, the packing rate and relative permeability of the magnetic core are readily improved compared to a situation where the magnetic core is manufactured using only the large-size powder or only the small-size powder. This is because voids between particles of the soft magnetic powder attributed to the large-size powder can be filled with particles of the soft magnetic powder attributed to the small-size powder.

The magnetic core may further include resin. Types of the resin are not limited. The resin may be, for example, an epoxy resin or a phenol resin. The resin content is not limited. The resin content may be, for example, 0.5 mass % or more and 5 mass % or less out of the entire magnetic core.

### (Method of Manufacturing Magnetic Core)

Methods of manufacturing the magnetic core according to the present embodiment are not limited. An example method of manufacturing the magnetic core (dust core) is described below.

First, the soft magnetic powder including the specific soft magnetic particles and a thermosetting resin are kneaded to give a resin compound. Then, a mold is filled with the resin compound. Then, the resin compound with which the mold is filled is pressure-molded to give a pressed body. Then, the resin included in the pressed body is thermally hardened to give the magnetic core (dust core).

For manufacture of the magnetic core, the soft magnetic powder in which the large-size powder and the small-size powder are mixed may be used.

Uses of the magnetic core according to the present embodiment are not limited. The magnetic core may be included in, for example, a coil device, such as an inductor, a choke coil, or a transformer. In particular, in a situation where the magnetic core according to the present embodiment is included in the coil device, the coil device satisfies both high inductance and good DC superimposition characteristics.

### EXAMPLES

Hereinafter, the present invention is described based on more detailed examples; however, the present invention is not limited to these examples.

### (Experiment 1)

A simple substance of Fe, a simple substance of Co, a simple substance of C, and/or a simple substance of a subcomponent were weighed so as to provide a mother alloy having a composition shown in the prepared composition column of Table 1. After a chamber was vacuumed, they were melted using high-frequency heating to give the mother alloy.

Prepared compositions and analyzed compositions in Table 1 are both shown in unit of wt %. An Fe 100 wt % composition is simply shown as Fe.

The resultant mother alloy was heated at 1500° C. to melt it to give a molten alloy. This provided a soft magnetic powder having an analyzed composition shown in Table 1. The atomization high-pressure liquid column shows a high-pressure liquid (high-pressure water or a high-pressure mixed liquid) used for manufacture of the soft magnetic powder. Samples whose high-pressure liquid column was marked with “Water 100%” were manufactured with a water atomization method using high-pressure water as a high-pressure liquid. Samples whose high-pressure liquid column was marked with “Water+ethanol X %” were manufactured with a water+organic solvent atomization method using a high-pressure mixed liquid as a high-pressure liquid. In Experiment 1, X was all 20.

Then, classification was carried out to give the soft magnetic powder having an average particle size shown in Table 1. To obtain a powder having an average particle size of 0.30 μm or more, a swirling airflow-driven air classifier (Aerofine Classifier manufactured by NISSHIN ENGINEERING INC.) was used for classification. To obtain a powder having an average particle size of less than 0.30 μm, an electrostatic classifier (Model 3082 manufactured by TSI) was used for classification.

That the average particle size of the resultant soft magnetic powder was as shown in Table 1 was confirmed using a laser diffraction particle size distribution analyzer (HELOS&RODOS manufactured by Sympatec GmbH).

With regard to the resultant soft magnetic powder, the content of elements other than carbon was measured by carrying out a quantitative analysis using ICP-AES (ICPS-8100CL manufactured by Shimadzu Corporation). The carbon content was measured by carrying out a quantitative analysis using a combustion in oxygen stream-infrared absorption method (CS-844 manufactured by LECO). From each element content of the soft magnetic powder, it was confirmed that the composition of the soft magnetic powder corresponded to the analyzed composition shown in Table 1.

The true density of the resultant soft magnetic powder was measured with an Archimedes method using a Warden type pycnometer.

The soft magnetic powder and an epoxy resin were kneaded to prepare a resin compound. The resin compound had a resin mass ratio of 2.5 mass %. As the epoxy resin, YSLV-80XY manufactured by NIPPON STEEL Chemical & Material Co., Ltd. was used.

A predetermined toroidal mold was filled with the resultant resin compound. With the molding pressure being controlled so that a magnetic core (toroidal core) eventually obtained had a packing rate of about 80%, pressure-molding was carried out to give a molded body. Specifically, the molding pressure was controlled within a range of 1 to 10 ton/cm².

The resin included in the molded body was thermally hardened at 180° C. for 60 minutes to give the toroidal core (outside diameter 11 mm, inside diameter 6.5 mm, thickness 2.5 to 3.0 mm).

The packing rate η of the soft magnetic powder in the toroidal core was calculated by dividing the density of the toroidal core calculated from its dimensions and its mass by the theoretical density of the toroidal core calculated from the true density of the various materials included in the toroidal core (in Experiment 1, the true density of the soft magnetic powder).

Inductance of the toroidal core at a frequency of 1 MHz was measured using an LCR meter (4284A manufactured by Agilent Technologies) and a DC bias power supply (42841A manufactured by Agilent Technologies). Then, from the inductance of the toroidal core, relative permeability of the toroidal core was calculated. The number of turns of wiring was 24. Relative permeability at a DC superimposition current of 0 A was defined as μ₀. A DC superimposition current at which relative permeability was decreased to 90% of μ₀ was defined as Isat. The higher the Isat, the better the DC superimposition characteristics.

The Isat improvement rate of Sample No. 1 was the rate of improvement from Isat of a Comparative Example whose analyzed composition was the same as that of the Example, i.e., from Isat of Sample No. 3. Note that the Isat improvement rate of Sample No. 2 was also shown as the rate of improvement from Isat of Sample No. 3. Hereinafter, Examples whose Isat improvement rate was 5% or more were deemed to have good DC superimposition characteristics; Examples whose Isat improvement rate was 10% or more were deemed to have better DC superimposition characteristics; and Examples whose Isat improvement rate was 20% or more were deemed to have best DC superimposition characteristics.

The toroidal core of each sample was cut, was embedded into TEM mesh grid Mo #200 using an epoxy resin, and was hardened at 130° C. This product was thinned using ion milling (PIPS manufactured by Gatan, Inc.) at an accelerating voltage of 4 kV and a milling angle of 4° to 5° to obtain an observation sample. Using a STEM (JEM-2100F manufactured by JEOL Ltd.), a bright field image of a field of view measuring about 3 μm×3 μm was observed to capture an electron diffraction image of about twenty particles in the field of view with a selected-area diffraction method. The area size was 300 nm Φ. The number of specific soft magnetic particles was divided by the number of soft magnetic particles to calculate the number ratio of the specific soft magnetic particles. Note that, in the captured electron diffraction image, a soft magnetic particle in which a diffraction spot attributed to a phase having a symmetry of a space group Im-3m or Pm-3m and a diffraction spot attributed to a phase having a symmetry of a space group Pnam were observed was deemed to be a specific soft magnetic particle.

### [Table 1]

TABLE 1

| | | Soft magnetic powder | | | |
|---|---|---|---|---|---|
| | | | | Average | |
| | | | | particle | Atomization |
| Sample | Example/ | Prepared composition | Analyzed composition | size | high-pressure |
| No. | Comparative Example | (wt %) | (wt %) | (μm) | liquid |
| 1 | Example | Fe | Fe_{99.8}C_{0.2} | 22.2 | Water + ethanol 20% |
| 2 | Comparative Example | Fe | Fe | 21.6 | Water 100% |
| 3 | Comparative Example | Fe_{99.2}C_{0.2} | Fe_{99.2}C_{0.2} | 22.3 | Water 100% |
| 4 | Example | Fe₈₀Co₂₀ | Fe_{79.85}Co_{19.95}C_{0.20} | 22.4 | Water + ethanol 20% |
| 5 | Comparative Example | Fe₈₀Co₂₀ | Fe₈₉Co₂₆ | 22.5 | Water 100% |
| 6 | Comparative Example | Fe_{79.85}Co_{19.95}C_{0.20} | Fe_{79.85}Co_{19.95}C_{0.30} | 22.1 | Water 100% |
| 7 | Example | Fe_{94.2}Si_{5.2}Cr_{0.5} | Fe_{94.1}Si_{5.2}Cr_{0.5}C_{0.2} | 21.9 | Water + ethanol 20% |
| 8 | Comparative Example | Fe_{94.3}Si_{5.2}Cr_{0.3} | Fe_{94.3}Si_{5.2}Cr_{0.5} | 21.8 | Water 100% |
| 9 | Comparative Example | Fe_{94.1}Si_{5.2}Cr_{0.5}C_{0.2} | Fe_{94.1}Si_{5.2}Cr_{0.5}C_{0.2} | 22.0 | Water 100% |
| 10 | Example | (Fe_{0.74}Co_{0.26})_{94.3}Si_{5.2}Cr_{0.5} | (Fe_{0.74}Co_{0.26})_{94.1}Si_{5.2}Cr_{0.5}C_{0.2} | 22.4 | Water + ethanol 20% |
| 11 | Comparative Example | (Fe_{0.74}Co_{0.26})_{94.3}Si5.7Cr_{0.5} | (Fe_{0.74}Co_{0.26})_{94.3}Si_{5.2}Cr_{0.5} | 21.9 | Water 100% |
| 12 | Comparative Example | (Fe_{0.74}Co_{0.26})_{94.1}Si_{5.2}Cr_{0.5}C_{0.3} | (Fe_{0.74}Co_{0.26})_{94.1}Si_{5.3}Cr_{0.5}C_{0.2} | 22.2 | Water 100% |

| | | Soft magnetic powder | | | | |
|---|---|---|---|---|---|---|
| | | Number ratio | Magnetic core | | | |
| | | of special | Packing | [symbol] | DC superimposition characteristics | |
| Sample | Example/ | soft magnetic | rate | permeability | | Isat improvement |
| No. | Comparative Example | particles (%) | η (%) | μ₀ | Isat (A) | rate |
| 1 | Example | 55 | 80.1 | 32.2 | 12.0 | 30% |
| 2 | Comparative Example | 0 | 79.8 | 32.5 | 9.2 | 0% |
| 3 | Comparative Example | 0 | 80.0 | 32.0 | 9.2 | 0% |
| 4 | Example | 60 | 80.3 | 31.9 | 12.3 | 34% |
| 5 | Comparative Example | 0 | 80.7 | 32.3 | 9.1 | −1% |
| 6 | Comparative Example | 0 | 80.2 | 32.1 | 9.2 | 0% |
| 7 | Example | 60 | 79.9 | 27.5 | 12.1 | 34% |
| 8 | Comparative Example | 0 | 80.3 | 27.4 | 9.1 | 1% |
| 9 | Comparative Example | 0 | 80.1 | 27.2 | 9.0 | 0% |
| 10 | Example | 55 | 80.1 | 27.3 | 12.0 | 29% |
| 11 | Comparative Example | 0 | 80.5 | 27.1 | 9.2 | −1% |
| 12 | Comparative Example | 0 | 80.5 | 27.0 | 9.3 | 0% |

[symbol]

indicates data missing or illegible when filed

Sample No. 2 was a sample that had the same prepared composition as that of Sample No. 1 but was manufactured with the water atomization method. Thus, the carbon content in the analyzed composition was different from that of Sample No. 1. Sample No. 3 was a sample that was manufactured with the water atomization method but had carbon added to the molten metal so that the carbon content in the analyzed composition was equivalent to that of Sample No. 1.

The soft magnetic powder of Sample No. 1 included the specific soft magnetic particles. Consequently, compared to the magnetic core including the soft magnetic powder of Sample No. 3, which was equivalent to the soft magnetic powder of Sample No. 1 except for not including the specific soft magnetic particles, the magnetic core including the soft magnetic powder of Sample No. 1 had equivalent μ₀ and improved DC superimposition characteristics.

Sample Nos. 4, 7, and 10 were carried out as in Sample No. 1 except that the prepared composition and the analyzed composition were changed from those of Sample No. 1. Sample Nos. 5, 8, and 11 were carried out as in Sample No. 2. Sample Nos. 6, 9, and 12 were carried out as in Sample No. 3.

Results of Sample Nos. 4 to 6, 7 to 9, and 10 to 12 were similar to those of Sample Nos. 1 to 3.

### (Experiment 2)

Examples carried out using the water+organic solvent atomization method (only Sample Nos. 43 were Comparative Examples) and corresponding Comparative Examples carried out using the water atomization method were compared, on condition that the analyzed composition was the same therebetween. Specifically, comparison similar to the comparison between Sample No. 1 (Example) and Sample No. 3 (Comparative Example) of Experiment 1 was carried out. Tables 2 to 6 show the results.

TABLE 2

| | | Soft magnetic powder | | | | |
|---|---|---|---|---|---|---|
| | | | | Average | | Number ratio |
| | | Prepared | Analyzed | particle | Atomization | of special |
| Sample | Example/ | composition | composition | size | high-pressure | soft magnetic |
| No. | Comparative Example | (wt %) | (wt %) | (μm) | liquid | particles (%) |
| 13 | Example | Fe₉₉Si₁ | Fe_{98.8}Si_{1.0}C_{0 2} | 22.0 | Water + ethanol 20% | 60 |
| 14 | Comparative | Fe_{98.8}Si_{1.0}C_{0.2} | Fe_{98.8}Si_{1.0}C_{0.2} | 22.2 | Water 100% | 0 |
| | Example | | | | | |
| 15 | Example | Fe₉₇Si₃ | Fe_{96.2}Si_{3.0}C_{0.2} | 22.3 | Water + ethanol 20% | 60 |
| 16 | Comparative | Fe_{96.2}Si_{3.0}C_{0.2} | Fe_{96.2}Si_{3.0}C_{0.2} | 22.4 | Water 100% | 0 |
| | Example | | | | | |
| 17 | Example | Fe_{95.5}Si_{4.5} | Fe_{95.3}Si_{4.5}C_{0.2} | 22.6 | Water + ethanol 20% | 60 |
| 18 | Comparative | Fe_{95.3}Si_{4.5}C_{0.2} | Fe_{95.3}Si_{4.5}C_{0.2} | 22.8 | Water 100% | 0 |
| | Example | | | | | |
| 19 | Example | Fe_{94.8}Si_{5.2} | Fe_{94.6}Si_{5.2}C_{0.2} | 22.2 | Water + ethanol 20% | 55 |
| 20 | Comparative | Fe_{94.6}Si_{5.2}C_{0.2} | Fe_{94.6}Si_{5.2}C_{0.2} | 22.5 | Water 100% | 0 |
| | Example | | | | | |
| 21 | Example | Fe_{93.5}Si_{6.5} | Fe_{93.3}Si_{6.5}C_{0.2} | 22.3 | Water + ethanol 20% | 60 |
| 22 | Comparative | Fe_{93.3}Si_{6.5}C_{0.2} | Fe_{23 3}Si_{5.5}C_{0.2} | 22.2 | Water 100% | 0 |
| | Example | | | | | |
| 23 | Example | Fe_{91.8}Si_{8.2} | Fe_{91.5}Si_{5.2}C_{0.2} | 22.4 | Water + ethanol 20% | 55 |
| 24 | Comparative | Fe_{97.5}Si_{8.2}C_{0.2} | Fe_{91.6}Si_{8.2}C_{0.2} | 22.1 | Water 100% | 0 |
| | Example | | | | | |
| 25 | Example | Fe_{88.3}Si_{11.2} | Fe_{88.6}Si_{11.2}C_{0.2} | 22.3 | Water + ethanol 20% | 55 |
| 26 | Comparative | Fe_{88.6}Si_{11.2}C_{0.2} | Fe_{88.6}Si_{11.2}C_{0.2} | 22.3 | Water 100% | 0 |
| | Example | | | | | |
| 27 | Example | Fe_{85.6}Si_{14.4} | Fe_{85.4}Si_{14.4}C_{0.2} | 22.3 | Water + ethanol 20% | 55 |
| 28 | Comparative | Fe_{85.4}Si_{14.4}C_{0.2} | Fe_{85.4}Si_{14.4}C_{0.2} | 22.4 | Water 100% | 0 |
| | Example | | | | | |

| | | Magnetic core | | | |
|---|---|---|---|---|---|
| | | | | DC superimposition | |
| | | | | characteristics | |
| | | Packing | Initial | | Isat |
| Sample | Example/ | rate | permeability | Isat | improvement |
| No. | Comparative Example | η (%) | μ₀ | (A) | rate |
| 13 | Example | 80.4 | 31.0 | 12.3 | 35% |
| 14 | Comparative | 80.2 | 31.2 | 9.1 | 0% |
| | Example | | | | |
| 15 | Example | 80.4 | 29.6 | 12.2 | 34% |
| 16 | Comparative | 80.1 | 29.8 | 9.1 | 0% |
| | Example | | | | |
| 17 | Example | 80.2 | 28.4 | 12.0 | 35% |
| 18 | Comparative | 80.3 | 28.5 | 8.9 | 0% |
| | Example | | | | |
| 19 | Example | 80.5 | 27.3 | 12.1 | 38% |
| 20 | Comparative | 80.4 | 27.3 | 8.8 | 0% |
| | Example | | | | |
| 21 | Example | 80.3 | 25.9 | 12.4 | 39% |
| 22 | Comparative | 80.2 | 25.8 | 8.9 | 0% |
| | Example | | | | |
| 23 | Example | 80.3 | 23.4 | 12.3 | 40% |
| 24 | Comparative | 79.9 | 23.6 | 8.8 | 0% |
| | Example | | | | |
| 25 | Example | 80.0 | 22.9 | 12.2 | 36% |
| 26 | Comparative | 80.2 | 22.8 | 9.0 | 0% |
| | Example | | | | |
| 27 | Example | 80.1 | 21.5 | 12.0 | 35% |
| 28 | Comparative | 79.9 | 21.3 | 8.9 | 0% |
| | Example | | | | |

TABLE 3A

| | | Soft magnetic powder | | | |
|---|---|---|---|---|---|
| | | | | Average | |
| | | | | particle | Atomization |
| Sample | Example/ | Prepared composition | Analyzed composition | size | high-pressure |
| No. | Comparative Example | (wt %) | (wt %) | (μm) | liquid |
| 19 | Example | Fe_{94.8}Si_{5.2} | Fe_{94.6}Si_{5.2}C_{0.2} | 22.2 | Water + ethanol 20% |
| 20 | Comparative Example | Fe_{94.6}Si_{5.2}C_{0.2} | Fe_{94.6}Si_{5.2}C_{0.2} | 22.5 | Water 100% |
| 29 | Example | (Fe_{0.99}Co_{0.01})_{94.8}Si_{5.2} | (Fe_{0.99}Co_{0.01})_{94.6}Si_{5.2}C_{0.2} | 22.2 | Water + ethanol 20% |
| 30 | Comparative Example | (Fe_{0.99}Co_{0.01})_{94.8}Si_{5.2}C_{0.2} | (Fe_{0.99}Co_{0.01}) | 22.3 | Water 100% |
| 29a | Example | (Fe_{0.95}Co_{0.55})_{94.8}Si_{5.2} | (Fe_{0.99}Co_{0.01}) | 22.4 | Water + ethanol 20% |
| 30a | Comparative Example | (Fe_{0.95}Co_{0.05})_{94.6}Si_{5.2}C_{0.2} | (Fe_{0.99}Co_{0.01}) | 22.3 | Water 100% |
| 31 | Example | (Fe_{0.90}Co_{0.10})_{94.8}Si_{5.2} | | 22.0 | Water + ethanol 20% |
| 32 | Comparative Example | (Fe_{0.90}Co_{0.10})_{94.6}Si_{5.2}C_{0.2} | (Fe_{0.99}Co_{0.01}) | 22.6 | Water 100% |
| 33 | Example | (Fe_{0.75}Co_{0.25})_{94.8}Si_{5.2} | (Fe_{0.99}Co_{0.01}) | 22.1 | Water + ethanol 20% |
| 34 | Comparative Example | (Fe_{0.75}Co_{0.25})_{94.5}Si_{5.2}C_{0.2} | (Fe_{0.99}Co_{0.01}) | 21.9 | Water 100% |
| 35 | Example | (Fe_{0.50}Co_{0.50})_{94.2}Si_{5.2} | (Fe_{0.99}Co_{0.01}) | 22.2 | Water + ethanol 20% |
| 36 | Comparative Example | (Fe_{0.25}Co_{0.75})_{94.8}Si_{5.2} | (Fe_{0.99}Co_{0.01}) | 22.2 | Water J00% |
| 37 | Example | (Fe_{0.2}Co_{0.75})_{94.8}Si_{5.2} | (Fe_{0.99}Co_{0.01}) | 22.2 | Water + ethanol 20% |
| 38 | Comparative Example | (Fe_{0.25}Co_{0.75})_{94.6}Si_{5.2}C_{0.2} | (Fe_{0.99}Co_{0.01}) | 22.4 | Water 100% |
| 39 | Example | (Fe_{0.10}Co_{0.90})_{94.8}Si_{5.2} | (Fe_{0.99}Co_{0.01}) | 21.4 | Water + ethanol 20% |
| 40 | Comparative Example | (Fe_{0.10}Co_{0.90})_{94.8}Si_{5.2}C_{0.2} | (Fe_{0.99}Co_{0.01})_{94.5}Si_{5.2}C_{0.2} | 21.9 | Water 100% |
| 41 | Example | (Fe_{0.01}Co_{0.99})_{94.8}Si_{5.2} | (Fe_{0.01}Co_{0.99})_{94.6}Si_{5.2}C_{0.2} | 22.0 | Water + ethanol 20% |
| 42 | Comparative Example | (Fe_{0.01}Co_{0.99})_{94.6}Si_{5.2}C_{0.2} | (Fe_{0.01}Co_{0.99})_{94.6}Si_{5.2}C_{0.2} | 22.3 | Water 100% |
| 43 | Comparative Example | Co_{94.8}Si_{5.2} | Co_{94.6}Si_{5.2}C_{0.2} | 22.2 | Water + ethanol 20% |
| 44 | Comparative Example | Co_{94.8}Si_{5.2}C_{0.2} | Co_{94.6}Si_{5.2}C_{6.2} | 22.1 | Water 100% |

| | | | Magnetic core | | | |
|---|---|---|---|---|---|---|
| | | Soft magnetic powder | | | DC superimposition | |
| | | Number ratio | | | characteristics | |
| | | of special | Packing | Initial | | Isst |
| Sample | Example/ | soft magnetic | rate | permeability | Isat | improvement |
| No. | Comparative Example | particles (%) | η (%) | μ₀ | (A) | rate |
| 19 | Example | 55 | 80.5 | 27.3 | 12.1 | 38% |
| 20 | Comparative Example | 0 | 80.4 | 27.3 | 8.8 | 0% |
| 29 | Example | 60 | 80.2 | 27.3 | 12.3 | 40% |
| 30 | Comparative Example | 0 | 80.2 | 27.4 | 8.8 | 0% |
| 29a | Example | 60 | 80.3 | 27.4 | 12.2 | 40% |
| 30a | Comparative Example | 0 | 80.4 | 27.3 | 8.7 | 0% |
| 31 | Example | 60 | 80.1 | 27.6 | 12.3 | 41% |
| 32 | Comparative Example | 0 | 79.9 | 27.6 | 8.7 | 0% |
| 33 | Example | 55 | 79.8 | 27.7 | 12.0 | 36% |
| 34 | Comparative Example | 0 | 79.9 | 27.6 | 8.8 | 0% |
| 35 | Example | 45 | 79.7 | 27.2 | 11.5 | 34% |
| 36 | Comparative Example | 0 | 79.7 | 27.3 | 8.6 | 0% |
| 37 | Example | 35 | 79.8 | 27.1 | 11.2 | 30% |
| 38 | Comparative Example | 0 | 79.9 | 27.2 | 8.6 | 0% |
| 39 | Example | 20 | 79.6 | 27.4 | 10.4 | 18% |
| 40 | Comparative Example | 0 | 79.5 | 27.4 | 8.8 | 0% |
| 41 | Example | 10 | 79.3 | 27.5 | 10.1 | 13% |
| 42 | Comparative Example | 0 | 79.4 | 27.3 | 8.9 | 0% |
| 43 | Comparative Example | 0 | 79.6 | 27.3 | 8.8 | 0% |
| 44 | Comparative Example | 0 | 79.5 | 27.2 | 8.8 | 0% |

TABLE 3B
Table 3B

| | | Soft magnetic powder | | | |
|---|---|---|---|---|---|
| | | Prepared | Analyzed | Average | Atomization |
| Sample | Example/ | composition | composition | particle | high-pressure |
| No. | Comparative Example | (wt %) | (wt %) | size | liquid |
| 1 | Example | Fe | Fe_{99.8}C_{0.2} | 22.2 | Water + ethanol 20% |
| 3 | Comparative Example | Fe_{99.8}C_{0.2} | Fe_{99.8}C_{0.2} | 22.3 | Water 100% |
| 29b | Example | Fe₉₉Co₁ | Fe_{98.8}Co₁C_{0.2} | 21.9 | Water + ethanol 20% |
| 30b | Comparative Example | Fe_{98.8}Co₁C_{0.2} | Fe_{98.8}Co₁C_{0.2} | 22.0 | Water 100% |
| 29c | Example | Fe₉₅Co₅ | Fe_{94.81}Co_{4.99}C_{0.2} | 22.2 | Water + ethanol 20% |
| 30c | Comparative Example | Fe_{94.21}Co_{4.99}C_{0.2} | Fe_{94.81}Co_{4.99}C_{0.2} | 22.3 | Water 100% |
| 31b | Example | Fe₉₀Co₁₀ | Fe_{89.8}Co₁₀C_{0.2} | 21.8 | Water + ethanol 20% |
| 32b | Comparative Example | Fe_{89.8}Co₁₀C_{0.2} | Fe_{89.8}Co₁₀C_{0.2} | 21.9 | Water 100% |
| 33b | Example | Fe₇₅Co₂₅ | Fe_{74.85}Co_{24.95}C_{0.3} | 22.0 | Water + ethanol 20% |
| 34b | Comparative Example | Fe_{74.85}Co24.95C_{0.2} | Fe_{74.85}Co_{24.94}C_{0.2} | 22.1 | Water 100% |
| 35b | Example | Fe₅₀Co₅₀ | Fe_{49.9}Co_{49.9}C_{0.2} | 21.9 | Water + ethanol 20% |
| 36b | Comparative Example | Fe_{49.9}Co_{49.9}C_{0.2} | Fe_{49.9}Co_{49.9}C_{0.2} | 21.9 | Water 100% |
| 37b | Example | Fe₂₅Co₇₅ | Fe_{24.95}Co_{74.84}C_{0.2} | 22.0 | Water + ethanol 20% |
| 386 | Comparative Example | Fe_{24.95}Co_{74.85}C_{0.2} | Fe_{24.95}Co_{74.85}C_{0.2} | 22.2 | Water 100% |
| 39b | Example | Fe₁₀Co₉₀ | Fe_{9.98}Co_{89.82}C_{0.2} | 22.4 | Water + ethanol 20% |
| 40b | Comparative Example | Fe_{9.98}Co_{89.22}C_{0.2} | Fe_{9.98}Co_{89.82}C_{0.2} | 22.3 | Water 100% |
| 41b | Example | Fe₁Co₉₉ | Fe₁Co₉₂C_{0.2} | 22.2 | Water + ethanol 20% |
| 42b | Comparative Example | Fe₁Co₉₈C_{0.2} | Fe₁Co₉₈C_{0.2} | 22.1 | Water 100% |
| 43b | Comparative Example | Co | Co_{99.0}C_{0.2} | 22.4 | Water + ethanol 20% |
| 44b | Comparative Example | Co_{99.8}C_{0.2} | Co_{99.8}C_{0.2} | 22.2 | Water 100% |

| | | | Magnetic core | | | |
|---|---|---|---|---|---|---|
| | | Soft magnetic powder | | | DC superimposition | |
| | | Number ratio | | | characteristics | |
| | | of special | Packing | Initial | | Isat |
| Sample | Example/ | soft magnetic | rate | permeability | Isat | improvement |
| No. | Comparative Example | particles (%) | η (%) | μ₀ | (A) | rate |
| 1 | Example | 55 | 80.1 | 32.2 | 11.9 | 35% |
| 3 | Comparative Example | 0 | 80.0 | 32.0 | 8.8 | 0% |
| 29b | Example | 60 | 80.1 | 32.1 | 12.0 | 36% |
| 30b | Comparative Example | 0 | 80.3 | 32.0 | 8.8 | 0% |
| 29c | Example | 55 | 80.1 | 31.9 | 12.1 | 34% |
| 30c | Comparative Example | 0 | 80.4 | 32.0 | 9.0 | 0% |
| 31b | Example | 60 | 80.2 | 32.1 | 12.1 | 33% |
| 32b | Comparative Example | 0 | 80.0 | 32.1 | 9.1 | 0% |
| 33b | Example | 60 | 80.1 | 32.0 | 12.3 | 35% |
| 34b | Comparative Example | 0 | 80.0 | 31.9 | 9.1 | 0% |
| 35b | Example | 50 | 79.9 | 31.8 | 11.6 | 26% |
| 36b | Comparative Example | 0 | 80.1 | 32.1 | 9.2 | 0% |
| 37b | Example | 40 | 79.7 | 32.2 | 11.3 | 24% |
| 386 | Comparative Example | 0 | 79.8 | 32.3 | 9.1 | 0% |
| 39b | Example | 20 | 79.6 | 32.1 | 10.6 | 16% |
| 40b | Comparative Example | 0 | 79.7 | 32.0 | 9.1 | 0% |
| 41b | Example | 10 | 79.5 | 31.9 | 10.0 | 11% |
| 42b | Comparative Example | 0 | 79.3 | 31.8 | 9.0 | 0% |
| 43b | Comparative Example | 0 | 79.7 | 32.0 | 8.8 | 0% |
| 44b | Comparative Example | 0 | 79.7 | 31.9 | 8.8 | 0% |

TABLE 4
Table 4

| | | Soft magnetic powder | | | |
|---|---|---|---|---|---|
| | | Prepared | Analyzed | Average | Atomization |
| Sample | Example/ | composition | composition | particle | high-pressure |
| No. | Comparative Example | (w(%) | (wt %) | size | liquid |
| 19 | Example | Fe_{94.8}Si_{5.2} | Fe_{94.6}Si_{5.2}C_{0.2} | 22.2 | Water + ethanol 20% |
| 20 | Comparative Example | Fe_{94.6}Si_{5.2}C_{0.2} | Fe_{94.6}Si_{5.2}C_{0.2} | 22.5 | Water 100% |
| 45 | Example | Fe_{94.6}Si_{5.2}Cr_{0.2} | Fe_{94.4}Si_{5.2}Cr_{5.2}C_{0.2} | 21.9 | Water -H ethanol 20% |
| 46 | Comparative Example | Fe_{94.4}Si_{5.2}Cr_{0.2}C_{0.2} | Fe_{94.4}Si_{5.2}Cr_{5.2}C_{0.2} | 21.8 | Water 100% |
| 7 | Example | Fe_{94.3}Si_{5.2}C_{r0.5} | Fe_{94.1}Si_{5.2}Cr_{0.5}C_{0.2} | 21.9 | Water + ethanol 20% |
| 9 | Comparative Example | Fe_{94.1}Si_{5.2}Cr_{0.5}C_{0.2} | Fe_{94.1}Si_{5.2}Cr_{0.5}C_{0.2} | 22.0 | Water 100% |
| 49 | Example | Fe_{93.8}Si_{5.2}Cr_{1.0} | Fe_{93.6}Si_{5.2}Cr_{1.0}C_{0.2} | 22.0 | Water + ethanol 20% |
| 50 | Comparative Example | Fe_{93.6}Si_{5.2}Cr_{1.0}C_{0.2} | Fe_{93.6}Si_{5.2}Cr_{1.0}C_{0.2} | 22.1 | Water 100% |
| 51 | Example | Fe_{92.8}Si_{5.2}Cr_{2.0} | Fe_{92.6}Si_{5.2}Cr_{2.0}C_{0.2} | 22.3 | Water + ethanol 20% |
| 52 | Comparative Example | Fe_{92.6}Si_{5.2}Cr_{2.0}C_{0.2} | Fe_{92.6}Si_{5.2}Cr_{2.0}C_{0.2} | 21.9 | Water 100% |
| 53 | Example | Fe_{91.5}Si_{3.7}Cr_{4.2} | Fe_{91.3}Si_{3.7}Cr_{4.8}C_{0.2} | 22.2 | Water + ethanol 20% |
| 54 | Comparative Example | Fe_{91.3}Si_{3.7}Cr_{4.8}C_{0.2} | Fe_{91.3}Si_{3.7}Cr_{4.8}C_{0.2} | 22.4 | Water 100% |
| 55 | Example | Fe_{89.5}Si_{3.7}Cr_{0.2} | Fe_{29.3}Si_{5.7}Cr_{4.8}C_{0.2} | 21.8 | Water + ethanol 20% |
| 56 | Comparative Example | Fe_{85.4}Si_{14.4}C_{0.2} | Fe_{85.4}Si_{14.4}C_{0.2} | 21.9 | Water 100% |

| | | | Magnetic core | | | |
|---|---|---|---|---|---|---|
| | | Soft magnetic powder | | | DC superimposition | |
| | | Number ratio | | | characteristics | |
| | | of special | Packing | Initial | | Isat |
| Sample | Example/ | soft magnetic | rate | permeability | Isat | improvement |
| No. | Comparative Example | particles (%) | η (%) | μ₀ | (A) | rate |
| 19 | Example | 55 | 80.5 | 27.3 | 12.1 | 38% |
| 20 | Comparative Example | 0 | 80.4 | 27.3 | 8.8 | 0% |
| 45 | Example | 60 | 79.9 | 27.4 | 12.0 | 35% |
| 46 | Comparative Example | 0 | 80.3 | 27.2 | 8.9 | 0% |
| 7 | Example | 60 | 79.9 | 27.5 | 12.1 | 34% |
| 9 | Comparative Example | 0 | 80.1 | 27.2 | 9.0 | 0% |
| 49 | Example | 55 | 80.4 | 26.7 | 11.9 | 34% |
| 50 | Comparative Example | 0 | 80.3 | 26.5 | 8.9 | 0% |
| 51 | Example | 55 | 80.1 | 24.6 | 12.0 | 35% |
| 52 | Comparative Example | 0 | 80.2 | 24.3 | 8.9 | 0% |
| 53 | Example | 55 | 80.2 | 23.5 | 12.2 | 36% |
| 54 | Comparative Example | 0 | 80.1 | 23.1 | 9.0 | 0% |
| 55 | Example | 50 | 80.4 | 23.0 | 12.1 | 38% |
| 56 | Comparative Example | 0 | 79.8 | 22.8 | 8.8 | 0% |

TABLE 5
Table 5

| | | Soft magnetic powder | | | |
|---|---|---|---|---|---|
| | | | | Average | |
| | | | | panicle | Atomization |
| Sample | Example/ | | Analyzed composition | size | high-pressure |
| No. | Comparative Example | Prepare d composition | (wt %) | (μm) | liquid |
| 57 | Example | (Fe_{89.5}Co_{10.5})_{93.6}Si_{6.4} | (Fe_{89.5}Co_{10.5})_{93.4}Si_{6.4}C_{0.2} | 22.1 | Water + ethanol 20% |
| 58 | Comparative Example | (Fe_{89.5}Co_{10.5})_{93.4}Si_{6.4}C_{0.2} | (Fe_{89.5}Co_{10.5})_{93.4}Si_{6.4}C_{0.2} | 22.4 | Water 100% |
| 59 | Example | (Fe_{89.5}Co_{10.5})_{92.4}Si_{6.4}Cr_{0.2} | (Fe_{89.5}Co_{10.5})_{93.2}Si_{6.4}Cr_{0.2}C_{0.2} | 22.0 | Water + ethanol 20% |
| 60 | Comparative Example | (Fe_{89.5}Co_{10.5})_{93.2}Si_{6.4}Cr_{0.2}C_{0.2} | (Fe_{89.5}Co_{10.5})_{93.2}Si_{6.4}Cr_{0.2}C_{0.2} | 22.2 | Water 100% |
| 61 | Example | (Fe_{89.5}Co_{10.5})_{93.1}Si_{6.4}Cr_{0.2} | (Fe_{89.5}Co_{10.5})_{92.9}Si_{6.4}C_{0.2} | 22.4 | Water + ethanol 20% |
| 62 | Comparative Example | (Fe_{89.5}Co_{10.5})_{92.9}Si_{6.4}Cr_{0.5}C_{0.2} | (Fe_{89.5}Co_{10.5})_{93.9}Si_{6.4}C_{0.2} | 22.5 | Water 100% |
| 63 | Example | (Fe_{89.5}Co_{10.5})_{92.6}Si_{6.4}Cr_{1.0} | (Fe_{89.5}Co_{10.5})_{92.4}Si_{6.4}Cr_{1.0}C_{0.2} | 22.1 | Water + ethanol 20% |
| 64 | Comparative Example | (Fe_{89.5}Co_{10.5})_{92.4}Si_{6.4}Cr_{1.0}C_{0.2} | (Fe_{89.5}Co_{10.5})_{92.4}Si_{6.4}Cr_{1.0}C_{0.2} | 22.3 | Water 100% |
| 65 | Example | (Fe_{89.5}Co_{10.5})_{91.6}Si_{6.4}Cr_{2.0} | (Fe_{89.5}Co_{10.5})_{91.4}Si_{6.4}C_{0.2} | 22.1 | Water + ethanol 20% |
| 66 | Comparative Example | (Fe_{89.5}Co_{10.5})_{91.4}Si_{6.4}Cr_{2.0}C_{0.2} | (Fe_{89.5}Co_{10.5})_{91.4}Si_{6.4}Cr_{2.0}C_{0.2} | 22.0 | Water 100% |
| 67 | Example | (Fe_{89.5}Co_{10.5})_{88.7}Si_{6.4}Cr4.9 | (Fe_{89.5}Co_{10.5})_{88.5}Si_{6.4}Cr_{4.9}C_{0.2} | 22.4 | Water + ethanol 20% |
| 68 | Comparative Example | (Fe_{89.5}Co_{10.5})_{88.5}Si_{6.4}Cr_{4.9}C_{0.2} | (Fe_{89.5}Co_{10.5})_{88.5}Si_{6.4}Cr_{4.9}C_{0.2} | 22.5 | Water 100% |
| 69 | Example | (Fe_{89.5}Co_{10.5})_{89.0}Si_{3.9}Cr_{7.1} | (Fe_{89.5}Co_{10.5})_{88.8}Si_{3.9}C_{0.2}Cr_{7.1}C_{0.2} | 21.9 | Water + ethanol 20% |
| 70 | Comparative Example | (Fe_{89.5}Co_{10.5})_{38.8}Si_{3.9}Cr_{7.1}C_{0.2} | (Fe_{89.5}Co_{10.5})_{83.8}Si_{3.9}Cr_{7.1}C_{0.2} | 21.8 | Water 100% |

| | | | Magnetic core | | | |
|---|---|---|---|---|---|---|
| | | Soft magnetic powder | | | DC superimposition | |
| | | Number ratio | | | characteristics | |
| | | of special | Packing | Initial | | Isat |
| Sample | Example/ | sod magnetic | rate | permeability | Isat | improvement |
| No. | Comparative Example | particles (%) | η (%) | μ₀ | (A) | rate |
| 57 | Example | 55 | 80.0 | 27.7 | 12.2 | 33% |
| 58 | Comparative Example | 0 | 80.4 | 27.5 | 9.2 | 0% |
| 59 | Example | 55 | 80.1 | 27.4 | 12.0 | 36% |
| 60 | Comparative Example | 0 | 80.2 | 27.4 | 8.8 | 0% |
| 61 | Example | 50 | 80.1 | 27.0 | 12.2 | 34% |
| 62 | Comparative Example | 0 | 80.3 | 26.8 | 9.1 | 0% |
| 63 | Example | 55 | 80.2 | 24.5 | 12.5 | 34% |
| 64 | Comparative Example | 0 | 80.0 | 24.1 | 9.3 | 0% |
| 65 | Example | 55 | 80.5 | 23.7 | 12.7 | 35% |
| 66 | Comparative Example | 0 | 80.2 | 23.5 | 9.4 | 0% |
| 67 | Example | 53 | 80.1 | 22.5 | 12.8 | 36% |
| 68 | Comparative Example | 0 | 80.2 | 22.6 | 9.4 | 0% |
| 69 | Example | 55 | 79.9 | 23.0 | 12.5 | 34% |
| 70 | Comparative Example | 0 | 80.4 | 22.9 | 9.3 | 0% |

TABLE 6
Table 6

| | | Soft magnetic powder | | | |
|---|---|---|---|---|---|
| | | | | Average | |
| | | | | particle | Atomization |
| Sample | Example/ | | | size | high-pressure |
| No. | Comparative Example | Prepared composition | Analyzed composition | (μm) | liquid |
| 71 | Example | (Fe_{0.74}Co_{0.26})_{94.8}Si_{5.2} | (Fe_{0.74}Co_{0.26})_{94.6}Si_{5.2}C_{0.2} | 22.2 | Water + ethanol 20% |
| 72 | Comparative Example | (Fe_{0.74}Co_{0.26})_{94.6}Si_{5.2}C_{0.2} | (Fe_{0.74}Co_{0.26})_{94.6}Si_{5.2}C_{0.2} | 22.0 | Water 100% |
| 73 | Example | (Fe_{0.74}Co_{0.26})_{94.6}Si_{5.2}Cr_{0.2} | (Fe_{0.74}Co_{0.26})_{94.4}Si_{5.2}Cr_{0.2}C_{0.2} | 21.8 | Water + ethanol 20% |
| 74 | Comparative Example | (Fe_{0.74}Co_{0.26})_{94.4}Si_{5.2}Cr_{0.2}C_{0.2} | (Fe_{0.74}Co_{0.26})_{94.4}Si_{5.2}C_{0.2} | 22.3 | Water 100% |
| 75 | Example | (Fe_{0.74}Co_{0.26})_{94.3}Si_{5.2}Cr_{0.5} | (Fe_{0.74}Co_{0.26})_{94.1}Si_{5.2}Cr_{0.5}C_{0.2} | 22.4 | Water + ethanol 20% |
| 76 | Comparative Example | (Fe_{0.74}Co_{0.26})_{94.1}Si_{5.2}Cr_{0.5}C_{0.2} | (Fe_{0.74}Co_{0.26})_{94.1}Si_{5.2}C_{0.2} | 22.2 | Water 100% |
| 77 | Example | (Fe_{0.74}Co_{0.26})_{0.28}Si_{5.2}C_{r1.0} | (Fe_{0.74}Co_{0.26})_{93.6}Si_{5.2}Cr_{1.0}C_{0.2} | 22.2 | Water + ethanol 20% |
| 78 | Comparative Example | (Fe_{0.74}Co_{0.36})_{93.6}Si_{5.2}Cr_{1.0}C_{0.2} | (Fe_{0.74}Co_{0.26})_{93.6}Si_{5.2}Cr_{1.0}C_{0.2} | 22.5 | Water 100% |
| 79 | Example | (Fe_{0.74}Co_{0.26})_{92.9}Si_{5.2}Cr_{1.9} | (Fe_{0.74}Co_{0.26})_{92.7}Si_{5.2}Cr_{1.9}C_{0.2} | 22.1 | Water + ethanol 20% |
| 80 | Comparative Example | (Fe_{0.74}Co_{0.26})_{92.7}Si_{5.2}Cr_{1.9}C_{0.2} | (Fe_{0.74}Co_{0.26})_{93.7}Si_{5.2}Cr_{1.9}C_{0.2} | 22.0 | Water 100% |
| 81 | Example | (Fe_{0.74}Co_{0.26})_{91.6}Si_{1.6}Cr_{4.8} | (Fe_{0.74}Co_{0.26})_{91.4}Si_{3.6}Cr_{4.8}C_{0.2} | 22.4 | Water + ethanol 20% |
| 82 | Comparative Example | (Fe_{0.74}Co_{0.26})_{91.4}Si_{5.6}C_{0.2} | (Fe_{0.74}Co_{0.26})_{91.4}Si_{3.6}Cr_{4.8}C_{0.2} | 22.2 | Water 100% |
| 83 | Example | (Fe_{0.74}Co_{0.26})_{89.7}Si_{3.6}C_{6.7} | (Fe_{0.74}Co_{0.26})_{89.5}Si_{3.6}Cr_{6.7}C_{0.2} | 22.3 | Water + ethanol 20% |
| 84 | Comparative Example | (Fe_{0.74}Co_{0.25})_{89.5}Si_{2.6}Cr_{5.7}C_{5.2} | (Fe_{0.74}Co_{0.26})_{89.5}Si_{3.6}Cr_{6.7}C_{0.2} | 21.9 | Water 100% |

| | | Soft magnetic powder | Magnetic core | | | |
|---|---|---|---|---|---|---|
| | | Number ratio | | | DC superimposition | |
| | | of special | Packing | Initial | characteristics | |
| Sample | Example/ | soft magnetic | rate | permeability | Isat | Isat |
| No. | Comparative Example | particles (%) | η (%) | μ₀ | (A) | rate |
| 71 | Example | 60 | 80.4 | 28.2 | 12.0 | 38% |
| 72 | Comparative Example | 0 | 80.2 | 22.0 | 2.7 | 0% |
| 73 | Example | 55 | 80.3 | 27.3 | 12.2 | 37% |
| 74 | Comparative Example | 0 | 80.4 | 27.5 | 8.9 | 0% |
| 75 | Example | 55 | 80.1 | 27.3 | 12.4 | 33% |
| 76 | Comparative Example | 0 | 80.5 | 27.0 | 9.3 | 0% |
| 77 | Example | 55 | 80.2 | 26.6 | 12.5 | 37% |
| 78 | Comparative Example | 0 | 80.4 | 26.4 | 9.1 | 0% |
| 79 | Example | 50 | 80.3 | 24.5 | 13.7 | 37% |
| 80 | Comparative Example | 0 | 79.9 | 24.4 | 9.3 | 0% |
| 81 | Example | 50 | 80.2 | 23.7 | 12.8 | 33% |
| 82 | Comparative Example | 0 | 80.0 | 23.6 | 9.6 | 0% |
| 83 | Example | 50 | 80.1 | 23.9 | 12.7 | 30% |
| 84 | Comparative Example | 0 | 80.3 | 22.8 | 9.8 | 0% |

Table 2 is a table showing experiment results of compositions referred to as Fe—Si based compositions in general. Table 3A is a table showing experiment results of compositions of Sample Nos. 19 and 20 in Table 2 with Fe partly or entirely being replaced with Co. Table 3B is a table showing experiment results of compositions of Sample Nos. 1 and 3 in Table 1 with Fe partly or entirely being replaced with Co. Table 4 is a table showing experiment results of compositions of Sample Nos. 19 and 20 with Fe and/or Si being replaced with Cr. Tables 5 and 6 are tables showing experiment results of compositions shown in Table 4 with Fe partly being replaced with Co and further the Fe, Co, and/or Si content being changed.

In any of situations where the composition of the soft magnetic powder was within a predetermined range, results were similar to those of Experiment 1. However, in a situation where the soft magnetic powder did not contain Fe, the soft magnetic powder did not include the specific soft magnetic particles even with the water+organic solvent atomization method being used.

### (Experiment 3)

Experiment 3 was conducted as in Sample Nos. 10 and 12 of Experiment 1 except that the carbon content in the analyzed composition was changed. In each Example, the composition of the mixed liquid was changed to change the carbon content in the analyzed composition. In each Comparative Example, the carbon content in the prepared composition was changed to change the carbon content in the analyzed composition. Table 7 shows the results.

TABLE 7

| | | Soft magnetic powder | | |
|---|---|---|---|---|
| | | | | Average |
| | | | | particle |
| Sample | Example/ | Prepared composition | Analyzed composition | size |
| No. | Comparative Example | (wt %) | (wt %) | (μm) |
| 85 | Example | (Fe_{0.74}Co_{0.26})_{94.3}Si_{5.2}Cr_{0.5} | (Fe_{0.74}Co_{0.26})_{93.8}Si_{5.2}Cr_{0.5}C_{0.5} | 21.4 |
| 86 | Comparative Example | (Fe_{0.74}Co_{0.26})_{93.8}Si_{5.2}Cr_{0.5}C_{0.} [symbol] | (Fe_{0.74}Co_{0.26})_{93.8}Si_{5.2}Cr_{0.5}C_{0.5} | 21.4 |
| 10 | Example | (Fe_{0.74}Co_{0.26})_{94.3}Si_{5.2}Cr_{0.} [symbol] | (Fe_{0.74}Co_{0.26})_{94.1}Si_{5.2}Cr_{0.} [symbol] C_{0.2} | 22.4 |
| 12 | Comparative Example | (Fe_{0.74}Co_{0.26})_{94.1}Si_{5.2}Cr_{0.5}C_{0.2} | (Fe_{0.74}Co_{0.26})_{94.1}Si_{5.2}Cr_{0.5}C_{0.2} | 22.2 |
| 87 | Example | (Fe_{0.74}Co_{0.26})_{94.3}Si_{5.2}Cr_{0.5} | (Fe_{0.74}Co_{0.26})_{94.2}Si_{5.2}Cr_{0.5}C_{0.1} | 22.5 |
| 88 | Comparative Example | (Fe [symbol] _{.74}Co_{0.2} [symbol] )_{94.2}Si_{5.2}Cr_{0.5}C_{0.1} | (Fe_{0.74}Co_{0.26})_{94.2}Si_{5.2}Cr_{0.5}C3z,899;_{.1} | 22.3 |
| 89 | Example | (Fe_{0.74}Co_{0.26})_{94.30}Si_{5.2}Cr_{0.5} | (Fe_{0.74}Co_{0.26})_{94.25}Si_{5.2}Cr_{0.5}C_{0.05} | 21.5 |
| 90 | Cooperative Example | (Fe_{0.7} [symbol] Co_{0.26})_{94.} [symbol] Si_{5.2}Cr [symbol] _{.5}C_{0.0} [symbol] | (Fe_{0.74}Co_{0.26})_{94.} [symbol] Si_{5.2}Cr_{0.5}C_{0.05} | 21.2 |
| 91 | Example | (Fe_{0.74}Co_{0.26})_{94.30}Si_{5.2}Cr_{0.5} | (Fe_{0.74}Co_{0.26})_{94.29}Si_{5.2}Cr_{0.5}C_{0.01} | 21.6 |
| 92 | Comparative Example | (Fe_{0.74}Co_{0.26})_{94.29}Si_{5.2}Cr_{0.5}C_{0.1} | (Fe_{0.74}Co_{0.26})_{94.29}Si_{5.2}Cr_{0.5}C_{0.01} | 21.4 |

| | Soft magnetic powder | | Magnetic core | | | |
|---|---|---|---|---|---|---|
| | | Number ratio | | | DC superimposition | |
| | | of special | Packing | | characteristics | |
| | Atomization | soft magnetic | rate | Initial | | Isat |
| Sample | high-pressure | particles | η | permeability | Isat | improvement |
| No. | liquid | (%) | (%) | μ₀ | (A) | rate |
| 85 | Water + ethanol 50% | 100 | 80.4 | 27.1 | 13.3 | 45% |
| 86 | Water 100% | 0 | 80.2 | 27.3 | 9.2 | 0% |
| 10 | Water + ethanol 20% | 5 [symbol] | 80.1 | 27.3 | 12.0 | 29% |
| 12 | Water 100% | 0 | 80.5 | 27.0 | 9.3 | 0% |
| 87 | Water + ethanol 10% | 25 | 80.0 | 26.9 | 11.3 | 22% |
| 88 | Water 100% | 0 | 80.1 | 27.0 | 9.3 | 0% |
| 89 | Water + ethanol 1% | 10 | 80.2 | 27.2 | 10.7 | 15% |
| 90 | Water 100% | 0 | 80.3 | 27.4 | 9.3 | 0% |
| 91 | Water + ethanol 0.5% | 5 | 80.2 | 27.0 | 10.0 | 8% |
| 92 | Water 100% | 0 | 79.9 | 27.1 | 9.3 | 0% |

[symbol]

indicates data missing or illegible when filed

According to Table 7, it was confirmed that, in a situation where the water+organic solvent atomization method was used, the higher the organic solvent content of the mixed liquid and the higher the carbon content in the analyzed composition, the larger the number ratio of the specific soft magnetic particles and the better the DC superimposition characteristics.

In contrast, in a situation where the water atomization method was used, the resultant soft magnetic powder did not include the specific soft magnetic particles regardless of the carbon content in the prepared composition. Also, influence of carbon on μ₀ and Isat of the magnetic cores was small.

### (Experiment 4)

Soft magnetic powders and magnetic cores were manufactured as in Sample Nos. 10 and 12 of Experiment 1 except that the average particle sizes of the soft magnetic powders were changed.

In Experiment 4, eddy current loss of the magnetic cores was evaluated as well. Eddy current loss was measured using a BH analyzer (SY-8218 manufactured by Iwatsu Measurement Co., Ltd.) with 24 turns of a primary winding, with 12 turns of a secondary winding, at a frequency of 3 MHz, at a measurement magnetic flux density of 10 mT. Table 8 shows the results.

TABLE 8

| | | Soft magnetic powder | | | |
|---|---|---|---|---|---|
| | | | | Average | |
| | | | | particle | Atomization |
| Sample | Example/ | Prepared composition | Analyzed composition | size | high-pressure |
| No. | Comparative Example | (wt %) | (wt %) | (μm) | liquid |
| 10 | Example | (Fe [symbol] _{.74}Co_{0.26})_{94.3}Si_{5.2}Cr_{0.} [symbol] | (Fe_{0.74}Co_{0.26})_{94.1}Si_{5.2}Cr_{0.5}C_{0.2} | 22.4 | Water + ethanol 20% |
| 12 | Comparative Example | (Fe_{0.74}Co_{0.26})_{94.1}Si_{5.2}Cr_{0.5}C_{0.2} | (Fe_{0.74}Co_{0.26})_{94.1}Si_{5.2}Cr_{0.5}C_{0.2} | 22.2 | Water 100% |
| 93 | Example | (Fe [symbol] _{.74}Co_{0.26})_{94.3}Si_{5.2}Cr_{0.} [symbol] | (Fe_{0.74}Co_{0.26})_{94.1}Si_{5.2}Cr_{0.5}C_{0.2} | 49.9 | Water + ethanol 20% |
| 94 | Comparative Example | (Fe_{0.74}Co_{0.26})_{94.1}Si_{5.2}Cr_{0.} [symbol] Cr_{0.2} | (Fe_{0.74}Co_{0.26})_{94.1}Si_{5.2}Cr_{0.5}C_{0.2} | 49.8 | Water 100% |
| 95 | Example | (Fe [symbol] _{.74}Co_{0.26})_{94.3}Si_{5.2}Cr_{0.} [symbol] | (Fe_{0.74}Co_{0.26})_{94.1}Si_{5.2}Cr_{0.5}C_{0.2} | 55.0 | Water + ethanol 20% |
| 96 | Comparative Example | (Fe_{0.74}Co_{0.26})_{94.1}Si_{5.2}Cr_{0.5}C_{0.2} | (Fe_{0.74}Co_{0.26})_{94.1}Si_{5.2}Cr_{0.5}C_{0.2} | 54.8 | Water 100% |

| | Soft magnetic powder | Magnetic core | | | | |
|---|---|---|---|---|---|---|
| | Number ratio | | | DC superimposition | | |
| | of special | Packing | | characteristics | | Eddy current |
| | soft magnetic | rate | Initial | | Isat | loss |
| Sample | particles | η | permeability | Isst | improvement | [symbol] |
| No. | (%) | (%) | μ₀ | (A) | rate | (kW/m³) |
| 10 | 55 | 80.1 | 27.3 | 12.0 | 29% | 675 |
| 12 | 0 | 80.5 | 27.0 | 9.3 | 0% | 672 |
| 93 | 50 | 80.4 | 31.2 | 10.6 | 43% | 934 |
| 94 | 0 | 80.3 | 31.1 | 7.4 | 0% | 947 |
| 95 | 50 | 80.1 | 36.9 | 10.5 | 44% | 1135 |
| 96 | 0 | 80.2 | 36.8 | 7.3 | 0% | 1141 |

[symbol]

indicates data missing or illegible when filed

According to Table 8, in a situation where the soft magnetic powder having an average particle size of 50.0 μm or less was used, it was confirmed that the larger the average particle size, the larger the μ₀ of the magnetic core, and the higher the Isat improvement rate. However, in a situation where the soft magnetic powder having an average particle size exceeding 50.0 μm was used, increases of μ₀ and the Isat improvement rate flattened out, and further eddy current loss increased.

Note that, even with the combination of Sample Nos. 10 and 12 being replaced with combinations of other samples of Experiments 1 to 3 and 6, there was a similar tendency. That is, in a situation where the soft magnetic powder having an average particle size of 50.0 μm or less was used, it was confirmed that the larger the average particle size, the larger the go of the magnetic core, and the higher the Isat improvement rate. However, in a situation where the soft magnetic powder having an average particle size exceeding 50.0 μm was used, increases of μ₀ and the Isat improvement rate flattened out, and further eddy current loss increased.

### (Experiment 5)

In Experiment 5, powders manufactured similarly to the soft magnetic powders of Experiments 1 to 4 except for having smaller average particle sizes were used as small-size powders. An amorphous powder was used as a large-size powder. The large-size powder had an average particle size of 22 μm and had a composition of Fe₇₃B₁₁Si₁₁C₃Cr₂. The corresponding small-size powder and the large-size powder were mixed to give a soft magnetic powder. The small-size powder content of the soft magnetic powder was as shown in each table.

Tables 9A and 9B show Examples and Comparative Examples in which the small-size powders having the same analyzed composition as that of the soft magnetic powders of Sample Nos. 1 and 3 were used. Table 10 shows Examples and Comparative Examples in which the small-size powders having the same analyzed composition as that of the soft magnetic powders of Sample Nos. 4 and 6 were used. Table 11 shows Examples and Comparative Examples in which the small-size powders having the same analyzed composition as that of Sample Nos. 7 and 9 were used. Table 12 shows Examples and Comparative Examples in which the small-size powders having the same analyzed composition as that of Sample Nos. 10 and 12 were used.

TABLE 9A

| | | Small-size powder | | | | |
|---|---|---|---|---|---|---|
| | | | | Average | | |
| | | Prepared | Analyzed | particle | | Atomization |
| Sample | Example/ | composition | composition | size | Content | high-pressure |
| No. | Comparative Example | (wt %) | (wt %) | (μm) | (wt %) | liquid |
| 97 | Example | Fe | Fe_{99.8}C_{0.2} | 3.0 | 20 | Water + ethanol 20% |
| 98 | Comparative Example | Fe_{99.8}C_{0.2} | Fe_{99.8}C_{0.2} | 3.0 | 20 | Water 100% |
| 99 | Example | Fe | Fe_{99.8}C_{0.2} | 1.0 | 20 | Water + ethanol 20% |
| 100 | Comparative Example | Fe_{99.8}C_{0.2} | Fe_{99.8}C_{0.2} | 1.0 | 20 | Water 100% |
| 101 | Example | Fe | Fe_{99.8}C_{0.2} | 0.10 | 20 | Water + ethanol 20% |
| 102 | Comparative Example | Fe_{99.8}C_{0.2} | Fe_{99.8}C_{0.2} | 0.10 | 20 | Water 100% |
| 103 | Example | Fe | Fe_{99.8}C_{0.2} | 0.08 | 20 | Water + ethanol 20% |
| 104 | Comparative Example | Fe_{99.8}C_{0.2} | Fe_{99.8}C_{0.2} | 0.08 | 20 | Water 100% |

| | Small-size powder | Magnetic core | | | |
|---|---|---|---|---|---|
| | Number ratio | | | DC superimposition | |
| | of special | Packing | | characteristics | |
| | so [symbol] magnetic | rate | Initial | | Isat |
| Sample | particles | η | permeability | Isat | improvement |
| No. | (%) | (%) | μ₀ | (A) | rate |
| 97 | 50 | 80.9 | 40.2 | 7.3 | 24% |
| 98 | 0 | 81.1 | 40.0 | 5.9 | 0% |
| 99 | 55 | 82.1 | 40.9 | 7.2 | 20% |
| 100 | 0 | 82.2 | 41.2 | 6.0 | 0% |
| 101 | 55 | 80.0 | 37.3 | 7.6 | 23% |
| 102 | 0 | 80.1 | 37.5 | 6.2 | 0% |
| 103 | 55 | 78.9 | 34.5 | 8.7 | 23% |
| 104 | 0 | 78.6 | 34.1 | 7.1 | 0% |

[symbol]

indicates data missing or illegible when filed

TABLE 9B

| | | Small-size powder | | | | |
|---|---|---|---|---|---|---|
| | | | | Average | | |
| | | | | particle | | Atomization |
| Sample | Example/ | Prepared composition | Analyzed composition | size | Content | high-pressure |
| No. | Comparative Example | (wt %) | (wt %) | (μm) | (wt %) | liquid |
| 97a | Example | Fe | Fe_{99.8}C_{0.2} | 3.0 | 10 | Water + ethanol 20% |
| 98a | Comparative Example | Fe_{99.8}C_{0.2} | Fe_{99.8}C_{0.2} | 3.0 | 10 | Water 100% |
| 97 | Example | Fe | Fe_{99.8}C_{0.2} | 3.0 | 20 | Water + ethanol 20% |
| 98 | Comparative Example | Fe_{99.8}C_{0.2} | Fe_{99.8}C_{0.2} | 3.0 | 20 | Water 100% |
| 97b | Example | Fe | Fe_{99.8}C_{0.2} | 3.0 | 40 | Water + ethanol 20% |
| 98b | Comparative Example | Fe_{99.8}C_{0.2} | Fe_{99.8}C_{0.2} | 3.0 | 40 | Water 100% |
| 97c | Example | Fe | Fe_{99.8}C_{0.2} | 3.0 | 80 | Water + ethanol 20% |
| 98c | Comparative Example | Fe_{99.8}C_{0.2} | Fe_{99.8}C_{0.2} | 3.0 | 80 | Water 100% |

| | Small-size powder | Magnetic core | | | |
|---|---|---|---|---|---|
| | Number ratio | | | DC superimposition | |
| | of special | Packing | | characteristics | |
| | soft magnetic | rate | Initial | | Isat |
| Sample | particles | η | permeability | Isat | improvement |
| No. | (%) | (%) | μ₀ | (A) | rate |
| 97a | 50 | 81.0 | 40.4 | 7.4 | 23% |
| 98a | 0 | 81.2 | 40.3 | 6.0 | 0% |
| 97 | 50 | 80.9 | 40.2 | 7.3 | 24% |
| 98 | 0 | 81.1 | 40.0 | 5.9 | 0% |
| 97b | 50 | 79.8 | 36.4 | 7.4 | 23% |
| 98b | 0 | 79.5 | 36.5 | 6.0 | 0% |
| 97c | 50 | 78.4 | 33.3 | 7.3 | 20% |
| 98c | 0 | 78.2 | 33.4 | 6.1 | 0% |

TABLE 10

| | | Small-size powder | | | | |
|---|---|---|---|---|---|---|
| | | | | Average | | |
| | | | | particle | | Atomization |
| Sample | Example/ | Prepared composition | Analyzed composition | size | Content | high-pressure |
| No. | Comparative Example | (wt %) | (wt %) | (μm) | (wt %) | liquid |
| 105 | Example | Fe₈₀Co₂₀ | Fe_{79.85}Co_{19.95}Co_{0.2} | 3.0 | 20 | Water + ethanol 20% |
| 106 | Comparative Example | Fe_{79.85}Co_{19.95}Co_{0.2} | Fe_{79.85}Co_{19.95}Co_{0.2} | 3.0 | 20 | Water 100% |
| 107 | Example | Fe₈₀Co₂₀ | Fe_{79.85}Co_{19.95}Co_{0.2} | 1.0 | 20 | Water + ethanol 20% |
| 108 | Comparative Example | Fe_{79.85}Co_{19.95}Co_{0.2} | Fe_{79.85}Co_{19.95}Co_{0.2} | 1.0 | 20 | Water 100% |
| 109 | Example | Fe₈₀Co₂₀ | Fe_{79.85}Co_{19.95}Co_{0.2} | 0.10 | 20 | Water + ethanol 20% |
| 110 | Comparative Example | Fe_{79.85}Co_{19.95}Co_{0.2} | Fe_{79.85}Co_{19.95}Co_{0.2} | 0.10 | 20 | Water 100% |
| 111 | Example | Fe₈₀Co₂₀ | Fe_{79.85}Co_{19.95}Co_{0.2} | 0.08 | 20 | Water + ethanol 20% |
| 112 | Comparative Example | Fe_{79.85}Co_{19.95}Co_{0.2} | Fe_{79.85}Co_{19.95}Co_{0.2} | 0.08 | 20 | Water 100% |

| | Small-size powder | Magnetic core | | | |
|---|---|---|---|---|---|
| | Number ratio | | | DC superimposition | |
| | of special | Packing | | characteristics | |
| | soft magnetic | rate | Initial | | Isat |
| Sample | particles | η | permeability | Isat | improvement |
| No. | (%) | (%) | μ₀ | (A) | rate |
| 105 | 55 | 81.1 | 40.0 | 7.4 | 25% |
| 106 | 0 | 81.0 | 40.1 | 5.9 | 0% |
| 107 | 55 | 82.2 | 40.5 | 7.3 | 22% |
| 108 | 0 | 81.7 | 40.4 | 6.0 | 0% |
| 109 | 60 | 80.6 | 36.9 | 7.9 | 25% |
| 110 | 0 | 80.4 | 36.7 | 6.3 | 0% |
| 111 | 60 | 79.3 | 34.8 | 8.8 | 26% |
| 112 | 0 | 79.5 | 34.7 | 7.0 | 0% |

TABLE 11

| | | Small-size powder | | | | |
|---|---|---|---|---|---|---|
| | | | | Average | | |
| | | | | particle | | Atomization |
| Sample | Example/ | Prepared composition | Analyzed composition | size | Content | high-pressure |
| No. | Comparative Example | (wt %) | (wt %) | (μm) | (wt %) | liquid |
| 113 | Example | Fe_{94.2}Si_{5.2}Cr_{0.} [symbol] | Fe_{94.1}Si_{5.2}Cr_{0.5}C_{0.} [symbol] | 3.0 | 20 | Water + ethanol 20% |
| 114 | Comparative Example | Fe_{94.1}Si_{5.2}Cr_{0.5}C_{0.} [symbol] | Fe_{94.1}Si_{5.} [symbol] Cr_{0.5}C_{0.2} | 3.0 | 20 | Water 100% |
| 115 | Example | Fe_{94.3}Si_{5.2}Cr_{0.5} | Fe_{94.1}Si_{5.2}Cr_{0.5}C_{0.} [symbol] | 1.0 | 20 | Walet + ethanol 20% |
| 116 | Comparative Example | Fe_{94.1}Si_{5.2}Cr_{0.} [symbol] C_{0.2} | Fe_{94.1}Si_{5.2}Cr_{0.5}C_{0.2} | 1.0 | 20 | Water 100% |
| 117 | Example | Fe_{94.3}Si_{5.2}Cr_{0.5} | Fe_{94.1}Si_{5.2}Cr_{0.5}C_{0.2} | 0.10 | 20 | Water + ethanol 20% |
| 118 | Comparative Example | Fe_{94.1}Si_{5.2}Cr_{0.5}C_{0.2} | Fe_{94.1}Si_{5.2}Cr_{0.5}C_{0.2} | 0.10 | 20 | Water 100% |
| 119 | Example | Fe_{94.3}Si_{5.2}Cr_{0.} [symbol] | Fe_{94.1}Si_{5.2}Cr_{0.} [symbol] C_{0.2} | 0.08 | 20 | Water + ethanol 20% |
| 120 | Comparative Example | Fe_{94.1}Si_{5.2}Cr_{0.5}C_{0.2} | Fe_{94.1}Si_{5.2}Cr_{0.5}C_{0.2} | 0.08 | 20 | Water 100% |

| | Small-size powder | Magnetic core | | | |
|---|---|---|---|---|---|
| | Number ratio | | | DC superimposition | |
| | of special | Packing | | characteristics | |
| | soft magnetic | rate | Initial | | Isat |
| Sample | particles | η | permeability | Isat | improvement |
| No. | (%) | (%) | μ₀ | (A) | rate |
| 113 | 55 | 81.0 | 40.1 | 7.2 | 24% |
| 114 | 0 | 81.1 | 39.9 | 5.8 | 0% |
| 115 | 55 | 80.8 | 40.3 | 7.2 | 26% |
| 116 | 0 | 80.9 | 40.3 | 5.7 | 0% |
| 117 | 55 | 80.6 | 37.7 | 7.8 | 22% |
| 118 | 0 | 80. [symbol] | 37.4 | 6.4 | 0% |
| 119 | 60 | 80.0 | 3 [symbol] .0 | 8.7 | 24% |
| 120 | 0 | 80.1 | 34.8 | 7.0 | 0% |

[symbol]

indicates data missing or illegible when filed

TABLE 12

| | | Small-size powder | | | |
|---|---|---|---|---|---|
| | | | | Average | |
| | | | | particle | |
| Sample | Example/ | Prepared composition | Analyzed composition | size | Content |
| No. | Comparative Example | (wt %) | (wt %) | (μm) | (wt %) |
| 121 | Example | (Fe_{0.74}Co_{0.26})_{94.3}Si_{5.2}Cr [symbol] | (Fe_{0.74}Co_{0.26})_{94.1}Si_{5.2}Cr_{0.5}Co_{0.2} | 3.0 | 20 |
| 122 | Comparative Example | (Fe_{0.74}Co_{0.26})_{94.1}Si_{5.2}Cr_{0.} [symbol] Co_{0.} [symbol] | (Fe_{0.74}Co_{0.26})_{94.1}Si_{5.2}Cr_{0.5}Co_{0.2} | 3.0 | 20 |
| 123 | Example | (Fe_{0.74}Co_{0.26})_{94.3}Si_{5.2}Cr_{0.5} | (Fe_{0.74}Co_{0.26})_{94.1}Si [symbol] _{.2}Cr_{0.} [symbol] Co_{0.2} | 1.0 | 20 |
| 124 | Comparative Example | (Fe_{0.74}Co_{0.26})_{94.1}Si_{5.2}Cr_{0.5}Co_{0.} [symbol] | (Fe_{0.7} [symbol] Co_{0.26})_{94.1}Si [symbol] _{.2}Cr_{0.5}Co_{0.2} | 1.0 | 20 |
| 123 | Example | (Fe_{0.74}Co_{0.26})_{94.3}Si [symbol] _{.2}Cr_{0.5} | (Fe_{0.74}Co_{0.26})_{94.1}Si_{5.2}Cr_{0.} [symbol] Co_{0.2} | 0.10 | 20 |
| 126 | Comparative Example | (Fe_{0.74}Co_{0.26})_{94.1}Si_{5.2}Cr_{0.5}Co_{0.2} | (Fe_{0.74}Co_{0.26}) [symbol] _{4.1}Si_{5.2}Cr_{0.} [symbol] Co_{0.2} | 0.10 | 20 |
| 127 | Example | (Fe_{0.74}Co_{0.2} [symbol] )_{94.3}Si [symbol] _{.2}Cr_{0.5} | (Fe_{0.74}Co_{0.26})_{94.1}Si_{5.2}Cr_{0.5}Co_{0.2} | 0.08 | 20 |
| 128 | Comparative Example | (Fe_{0.74}Co_{0.2} [symbol] )_{94.1}Si_{5.2}Cr_{0.5}Co_{0.2} | (Fe_{0.74}Co_{0.26})_{94.1}Si_{5.2}Cr_{0.5}Co_{0.2} | 0.08 | 20 |

| | Small-size powder | | Magnetic core | | | |
|---|---|---|---|---|---|---|
| | | Number ratio | | | DC superimposition | |
| | | of special | Packing | | characteristics | |
| | Atomization | soft magnetic | rate | Initial | | Isat |
| Sample | high-pressure | particles | η | permeability | Isat | improvement |
| No. | liquid | (%) | (%) | μ₀ | (A) | rate |
| 121 | Water + ethanol 20% | 55 | 80.7 | 39.9 | 7.5 | 25% |
| 122 | Water 100% | 0 | 80.6 | 39.6 | 6.0 | 0% |
| 123 | Water + ethanol 20% | 60 | 80.7 | 39.9 | 7.9 | 25% |
| 124 | Water 100% | 0 | 80.5 | 39.4 | 6.3 | 0% |
| 123 | Water + ethanol 20% | 60 | 80.1 | 36.5 | 2.1 | 23% |
| 126 | Water 100% | 0 | 80.2 | 36.1 | 5.5 | 0% |
| 127 | Water + ethanol 20% | 60 | 79.9 | 34.4 | 9.0 | 25% |
| 128 | Water 100% | 0 | 79.8 | 34.5 | 7.2 | 0% |

[symbol]

indicates data missing or illegible when filed

According to Tables 9A, 9B, and 10 to 12, it was confirmed that the larger the average particle sizes of the small-size powders, the higher the po of the magnetic cores. It was also confirmed that DC superimposition characteristics were improved when the soft magnetic powders used as the small-size powders included the specific soft magnetic particles.

### (Experiment 6)

Experiment 6 was conducted under equivalent conditions except that each component content, such as the subcomponent content, in the analyzed composition was appropriately changed. Tables 13 to 20 show the results.

TABLE 13

| | | Soft magnetic powder | | |
|---|---|---|---|---|
| | | | | Average |
| | | | | particle |
| Sample | Example/ | Prepared composition | Analyzed composition | size |
| No. | Comparative Example | (wt %) | (wt %) | (μm) |
| 129 | Example | Fe_{91.6}Si_{6.4}Cr_{2.0} | Fe_{91.4}Si_{6.4}Cr_{2.0}C_{0.2} | 22.3 |
| 130 | Comparative Example | Fe_{91.4}Si_{6.4}Cr_{2.0}C_{0.2} | Fe_{91.4}Si_{6.4}Cr_{2.0}C_{0.2} | 22.1 |
| 131 | Example | Fe_{91.5}Si_{6.4}Cr_{2.0}C_{0.1} | Fe_{91.3}Si_{6.4}Cr_{2.0}C_{0.3} | 22.2 |
| 132 | Comparative Example | Fe_{91.3}Si_{6.4}Cr_{2.0}C_{0.3} | Fe_{91.3}Si_{6.4}Cr_{2.0}C_{0.3} | 22.0 |
| 133 | Example | Fe_{91.2}Si_{6.5}Cr_{2.0}C_{0.3} | Fe_{91.0}Si_{6.5}Cr_{2.0}C_{0.5} | 22.1 |
| 134 | Comparative Example | Fe_{91.0}Si_{6.5}Cr_{2.0}C_{0.5} | Fe_{91.0}Si_{6.5}Cr_{2.0}C_{0.5} | 21.9 |
| 135 | Example | Fe_{91.3}Si_{6.5}Cr_{2.0}Al_{0.3} | Fe_{91.1}Si_{6.5}Cr_{2.0}Al_{0.3}C_{0.2} | 22.4 |
| 136 | Comparative Example | Fe_{91.1}Si_{6.5}Cr_{2.0}Al_{0.3}C_{0.2} | Fe_{91.1}Si_{6.5}Cr_{2.0}Al_{0.3}C_{0.2} | 22.4 |
| 137 | Example | Fe_{90.5}Si_{6.5}Cr_{2.0}Al_{1.0} | Fe_{90.3}Si_{6.5}Cr_{2.0}Al_{1.0}C_{0.2} | 22.1 |
| 138 | Comparative Example | Fe_{90.3}Si_{6.5}Cr_{2.0}Al_{1.0}C_{0.2} | Fe_{90.3}Si_{6.5}Cr_{2.0}Al_{1.0}C_{0.2} | 22.5 |
| 139 | Example | Fe_{91.6}Si_{6.4}Cr_{2.0}S_{0.015} | Fe_{91.4}Si_{6.4}Cr_{2.0}S_{0.015}C_{0.2} | 22.3 |
| 140 | Comparative Example | Fe_{91.4}Si_{6.4}Cr_{2.0}S_{0.015}C_{0.2} | Fe_{91.4}Si_{6.4}Cr_{2.0}S_{0.015}C_{0.2} | 22.0 |
| 141 | Example | Fe_{91.5}Si_{6.4}Cr_{2.0}S_{0.011} | Fe_{91.3}Si_{6.4}Cr_{2.0}S_{0.061}C_{0.2} | 22.0 |
| 142 | Comparative Example | Fe_{91.3}Si_{6.4}Cr_{2.0}S_{0.061}C_{0.2} | Fe_{91.3}Si_{6.4}Cr_{2.0}S_{0.061}C_{0.2} | 21.8 |
| 143 | Example | Fe_{91.1}Si_{6.4}Cr_{2.0}Ti_{0.5} | Fe_{90.9}Si_{6.4}Cr_{2.0}Ti_{0.5}C_{0.2} | 22.4 |
| 144 | Comparative Example | Fe_{90.9}Si_{6.4}Cr_{2.0}Ti_{0.5}C_{0.2} | Fe_{90.9}Si_{6.4}Cr_{2.0}Ti_{0.5}C_{0.2} | 22.2 |
| 145 | Example | Fe_{89.7}Si_{6.5}Cr_{2.0}Ti_{1.8} | Fe_{90.9}Si_{6.5}Cr_{2.0}Ti_{1.8}C_{0.2} | 22.1 |
| 146 | Comparative Example | Fe_{89.5}Si_{6.5}Cr_{2.0}Ti_{1.8}C_{0.2} | Fe_{90.9}Si_{6.5}Cr_{2.0}Ti_{1.8}C_{0.2} | 22.3 |

| | Soft magnetic powder | | Magnetic core | | | |
|---|---|---|---|---|---|---|
| | | Number ratio | | | DC superimposition | |
| | | of special | Packing | | characteristics | |
| | Atomization | soft magnetic | rate | Initial | | Isat |
| Sample | high-pressure | particles | η | permeability | Isat | improvement |
| No. | liquid | (%) | (%) | μ₀ | (A) | rate |
| 129 | Water + ethanol 20% | 55 | 80.1 | 23.5 | 12.1 | 32% |
| 130 | Water 100% | 0 | 80.2 | 23.4 | 9.2 | 0% |
| 131 | Water + ethanol 20% | 50 | 80.2 | 23.5 | 12.2 | 33% |
| 132 | Water 100% | 0 | 80.3 | 23.5 | 9.2 | 0% |
| 133 | Water + ethanol 20% | 50 | 80.1 | 23.4 | 12.2 | 31% |
| 134 | Water 100% | 0 | 80.4 | 23.3 | 9.3 | 0% |
| 135 | Water + ethanol 20% | 50 | 80.2 | 23.2 | 12.4 | 32% |
| 136 | Water 100% | 0 | 80.2 | 23.4 | 9.4 | 0% |
| 137 | Water + ethanol 20% | 50 | 80.3 | 23.6 | 12.2 | 34% |
| 138 | Water 100% | 0 | 80.1 | 23.5 | 9.1 | 0% |
| 139 | Water + ethanol 20% | 60 | 80.3 | 23.4 | 12.3 | 34% |
| 140 | Water 100% | 0 | 80.2 | 23.6 | 9.2 | 0% |
| 141 | Water + ethanol 20% | 50 | 80.3 | 23.5 | 12.0 | 33% |
| 142 | Water 100% | 0 | 80.1 | 23.4 | 9.0 | 0% |
| 143 | Water + ethanol 20% | 50 | 80.0 | 23.4 | 12.1 | 33% |
| 144 | Water 100% | 0 | 80.2 | 23.3 | 9.1 | 0% |
| 145 | Water + ethanol 20% | 50 | 80.1 | 23.2 | 12.0 | 33% |
| 146 | Water 100% | 0 | 80.1 | 23.3 | 9.0 | 0% |

TABLE 14

| | | Soft magnetic powder | | |
|---|---|---|---|---|
| | | | | Average |
| | | | | particle |
| Sample | Example/ | Prepared composition | Analyzed composition | size |
| No. | Comparative Example | (wt %) | (wt %) | (μm) |
| 147 | Example | Fe_{91.1}Si_{6.4}Cr_{2.0}V_{0.5} | Fe_{90.9}Si_{6.4}Cr_{2.0}V_{0.5}C_{0.2} | 22.0 |
| 148 | Comparative Example | Fe_{90.9}Si_{6.4}Cr_{2.0}V_{0.5}C_{0.2} | Fe_{90.9}Si_{6.4}Cr_{2.0}V_{0.5}C_{0.2} | 22.1 |
| 149 | Example | Fe_{89.6}Si_{6.4}Cr_{2.0}V_{2.0} | Fe_{89.6}Si_{6.4}Cr_{2.0}V_{2.0}C_{0.2} | 22.0 |
| 150 | Comparative Example | Fe_{89.6}Si_{6.4}Cr_{2.0}V_{2.0}C_{0.2} | Fe_{89.6}Si_{6.4}Cr_{2.0}V_{2.0}C_{0.2} | 22.3 |
| 151 | Example | Fe_{91.1}Si_{6.4}Cr_{2.0}Mn_{0.5} | Fe_{90.9}Si_{6.4}Cr_{2.0}Mn_{0.5}C_{0.2} | 22.1 |
| 152 | Comparative Example | Fe_{90.9}Si_{6.4}Cr_{2.0}Mn_{0.5}C_{0.2} | Fe_{90.9}Si_{6.4}Cr_{2.0}Mn_{0.5}C_{0.2} | 22.2 |
| 153 | Example | Fe_{89.5}Si_{6.4}Cr_{2.0}Mn_{2.1} | Fe_{89.3}Si_{6.4}Cr_{2.0}Mn_{2.1}C_{0.2} | 22.1 |
| 154 | Comparative Example | Fe_{89.3}Si_{6.4}Cr_{2.0}Mn_{2.1}C_{0.2} | Fe_{89.3}Si_{6.4}Cr_{2.0}Mn_{2.1}C_{0.2} | 22.0 |
| 155 | Example | Fe_{91.0}Si_{6.4}Cr_{2.0}Ni_{0.6} | Fe_{91.0}Si_{6.4}Cr_{2.0}Ni_{0.6}C_{0.2} | 22.4 |
| 156 | Comparative Example | Fe_{91.0}Si_{6.4}Cr_{2.0}Ni_{0.6}C_{0.} [symbol] | Fe_{91.0}Si_{6.4}Cr_{2.0}Ni_{0.6}C_{0.2} | 22.5 |
| 157 | Example | Fe_{89.4}Si_{6.4}Cr_{2.0}Ni_{2.2} | Fe_{89.2}Si_{6.4}Cr_{2.0}Ni_{2.2}C_{0.2} | 22.3 |
| 158 | Comparative Example | Fe_{89.2}Si_{6.4}Cr_{2.0}Ni_{2.} [symbol] C_{0.2} | Fe_{89.2}Si_{6.4}Cr_{2.0}Ni_{2.2}C_{0.2} | 22.3 |
| 159 | Example | Fe_{91.0}Si_{6.4}Cr_{2.0}Cu_{0.6} | Fe_{90.8}Si_{6.4}Cr_{2.0}Cu_{0.6}C_{0.2} | 22.4 |
| 160 | Comparative Example | Fe_{90.8}Si_{6.4}Cr_{2.0}Cu_{0.6}C_{0.2} | Fe_{90.8}Si_{6.4}Cr_{2.0}Cu_{0.6}C_{0.2} | 22.5 |
| 161 | Example | Fe_{89.2}Si_{6.4}Cr_{2.0}Cu_{2.4} | Fe_{89.0}Si_{6.4}Cr_{2.0}Cu_{2.4}C_{0.2} | 22.2 |
| 162 | Comparative Example | Fe_{89.0}Si_{6.4}Cr_{2.0}Cu_{2.4}C_{0.2} | Fe_{89.0}Si_{6.4}Cr_{2.0}Cu_{2.4}C_{0.2} | 22.5 |
| 163 | Example | Fe_{90.7}Si_{6.4}Cr_{2.0}Zr_{0.9} | Fe_{90.5}Si_{6.4}Cr_{2.0}Zr_{0.9}C_{0.2} | 22.4 |
| 164 | Comparative Example | Fe_{90.5}Si_{6.4}Cr_{2.0}Zr_{0.9}C_{0.2} | Fe_{90.5}Si_{6.4}Cr_{2.0}Zr_{0.9}C_{0.2} | 22.3 |
| 163 | Example | Fe_{88.3}Si_{6.3}Cr_{2.0}Zr_{3.4} | Fe_{88.1}Si_{6.3}Cr_{2.0}Zr_{3.4}C_{0.2} | 22.6 |
| 166 | Comparative Example | Fe_{88.1}Si_{6.3}Cr_{2.0}Zr_{3.4}C_{0.2} | Fe_{88.1}Si_{6.3}Cr_{2.0}Zr_{3.4}C_{0.2} | 22.5 |

| | Soft magnetic powder | | Magnetic core | | | |
|---|---|---|---|---|---|---|
| | | Number ratio | | | DC superimposition | |
| | | of special | Packing | | characteristics | |
| | Atomization | soft magnetic | rate | Initial | | Isat |
| Sample | high-pressure | particles | η | permeability | Isat | improvement |
| No. | liquid | (%) | (%) | μ₀ | (A) | rate |
| 147 | Water + ethanol 20% | 55 | 80.2 | 23.3 | 12.1 | 33% |
| 148 | Water 100% | 0 | 80.3 | 23.5 | 9.1 | 0% |
| 149 | Water + ethanol 20% | 50 | 80.1 | 23.4 | 12.2 | 33% |
| 150 | Water 100% | 0 | 80.3 | 23.4 | 9.2 | 0% |
| 151 | Water + ethanol 20% | 50 | 80.0 | 23.3 | 12.1 | 34% |
| 152 | Water 100% | 0 | 80.4 | 23.2 | 9.0 | 0% |
| 153 | Water + ethanol 20% | 50 | 80.3 | 23.4 | 12.3 | 34% |
| 154 | Water 100% | 0 | 80.1 | 23.3 | 9.2 | 0% |
| 155 | Water + ethanol 20% | 50 | 79.0 | 23.5 | 12.4 | 35% |
| 156 | Water 100% | 0 | 80.0 | 23.4 | 9.2 | 0% |
| 157 | Water + ethanol 20% | 50 | 80.1 | 23.3 | 12.3 | 35% |
| 158 | Water 100% | 0 | 80.2 | 23.J | 9.1 | 0% |
| 159 | Water + ethanol 20% | 50 | 80.4 | 23.4 | 12.2 | 31% |
| 160 | Water 100% | 0 | 80.4 | 23.3 | 9.3 | 0% |
| 161 | Water + ethanol 20% | 55 | 80.3 | 23.1 | 12.4 | 35% |
| 162 | Water 100% | 0 | 80.2 | 23.0 | 9.2 | 0% |
| 163 | Water + ethanol 20% | 50 | 80.2 | 23.4 | 12.1 | 36% |
| 164 | Water 100% | 0 | 80.0 | 23.3 | 8.9 | 0% |
| 163 | Water + ethanol 20% | 50 | 80.1 | 22.9 | 12.0 | 33% |
| 166 | Water 100% | 0 | 80.2 | 22.9 | 9.0 | 0% |

[symbol]

indicates data missing or illegible when filed

TABLE 15

| | | Soft magnetic powder | | |
|---|---|---|---|---|
| | | | | Average |
| | | | | particle |
| Sample | Example/ | Prepared composition | Analyzed composition | size |
| No. | Comparative Example | (wt %) | (wt %) | (μm) |
| 167 | Example | Fe_{90.8}Si_{6.4}Cr_{2.0}Nb_{0.9} | Fe_{90.6}Si_{6.4}Cr_{2.0}Nb_{0.9}C_{0.2} | 21.9 |
| 168 | Comparative Example | Fe_{90.6}Si_{6.4}Cr_{2.0}Nb_{0.9}C_{0.2} | Fe_{90.6}Si_{6.4}Cr_{2.0}Nb_{0.9}C_{0.2} | 22.0 |
| 169 | Example | Fe_{80.2}Si_{6.3}Cr_{2.0}Nb_{3.5} | Fe_{88.0}Si_{6.3}Cr_{2.0}Nb_{3.5}C_{0.2} | 22.3 |
| 170 | Comparative Example | Fe_{88.0}Si_{6.3}Cr_{2.0}Nb_{3.5}C_{0.2} | Fe_{88.0}Si_{6.3}Cr_{2.0}Nb_{3.5}C_{0.2} | 22.3 |
| 171 | Example | Fe_{90.7}Si_{6.4}Cr_{2.0}Mo_{0.9} | Fe_{90.5}Si_{6.4}Cr_{2.0}Mo_{0.9}C_{0.2} | 22.3 |
| 172 | Comparative Example | Fe_{90.5}Si_{6.4}Cr_{2.0}Mo_{0.9}C_{0.2} | Fe_{90.5}Si_{6.4}Cr_{2.0}Mo_{0.9}C_{0.2} | 22.2 |
| 173 | Example | Fe_{88.1}Si_{6.3}Cr_{2.0}Mo_{3.6} | Fe_{87.9}Si_{6.3}Cr_{2.0}Mo_{3.6}C_{0.2} | 22.1 |
| 174 | Comparative Example | Fe_{87.9}Si_{6.3}Cr_{2.0}Mo_{3.6}C_{0.2} | Fe_{87.9}Si_{6.3}Cr_{2.0}Mo_{3.6}C_{0.2} | 21.9 |
| 175 | Example | Fe_{90.0}Si_{6.3}Cr_{2.0}Hf_{1.7} | Fe_{89.8}Si_{6.3}Cr_{2.0}Hf_{1.7}C_{0.2} | 22.3 |
| 176 | Comparative Example | Fe_{89.8}Si_{6.3}Cr_{2.0}Hf_{1.7}C_{0.2} | Fe_{89.8}Si_{6.3}Cr_{2.0}Hf_{1.7}C_{0.2} | 22.4 |
| 177 | Example | Fe_{85.5}Si_{6.1}Cr_{1.9}Hf_{6.5} | Fe_{85.3}Si_{6.1}Cr_{1.9}Hf_{6.5}C_{0.2} | 22.5 |
| 178 | Comparative Example | Fe_{85.3}Si_{6.1}Cr_{1.9}Hf_{6.5}C_{0.2} | Fe_{85.3}Si_{6.1}Cr_{1.9}Hf_{6.5}C_{0.2} | 22.1 |
| 179 | Example | Fe_{90.0}Si_{6.3}Cr_{2.0}Ta_{1.7} | Fe_{89.8}Si_{6.3}Cr_{2.0}Ta_{1.7}C_{0.2} | 22.0 |
| 180 | Comparative Example | Fe_{89.8}Si_{6.3}Cr_{2.0}Ta_{1.7}C_{0.2} | Fe_{89.8}Si_{6.3}Cr_{2.0}Ta_{1.7}C_{0.2} | 22.3 |
| 181 | Example | Fe_{85.4}Si_{6.1}Cr_{1.9}Ta_{6.6} | Fe_{85.2}Si_{6.1}Cr_{1.9}Ta_{6.6}C_{0.2} | 22.2 |
| 182 | Comparative Example | Fe_{85.2}Si_{6.1}Cr_{1.9}Ta_{6.6}C_{0.2} | Fe_{85.2}Si_{6.1}Cr_{1.9}Ta_{6.6}C_{0.2} | 22.4 |
| 183 | Example | Fe_{90.0}Si_{6.3}Cr_{2.0}W_{1.7} | Fe_{89.8}Si_{6.3}Cr_{2.0}W_{1.7}C_{0.2} | 22.5 |
| 184 | Comparative Example | Fe_{89.8}Si_{6.3}Cr_{2.0}W_{1.7}C_{0.2} | Fe_{89.8}Si_{6.3}Cr_{2.0}W_{1.7}C_{0.2} | 22.4 |
| 185 | Example | Fe_{85.3}Si_{6.1}Cr_{1.9}W_{1.7} | Fe_{85.1}Si_{6.1}Cr_{1.9}W_{1.7}C_{0.2} | 22.1 |
| 186 | Comparative Example | Fe_{85.1}Si_{6.1}Cr_{1.9}W_{1.7}C_{0.2} | Fe_{85.1}Si_{6.1}Cr_{1.9}W_{1.7}C_{0.2} | 22.1 |

| | Soft magnetic powder | | Magnetic core | | | |
|---|---|---|---|---|---|---|
| | | Number ratio | | | DC superimposition | |
| | | of special | Packing | | characteristics | |
| | Atomization | soft magnetic | rate | Initial | | Isat |
| Sample | high-pressure | particles | η | permeability | Isat | improvement |
| No. | liquid | (%) | (%) | μ₀ | (A) | rate |
| 167 | Water + ethanol 20% | 50 | 80.2 | 23.1 | 12.2 | 34% |
| 168 | Water 100% | 0 | 80.1 | 23.2 | 9.1 | 0% |
| 169 | Water + ethanol 20% | 55 | 80.3 | 22.8 | 12.3 | 32% |
| 170 | Water 100% | 0 | 80.3 | 22.8 | 9.3 | 0% |
| 171 | Water + ethanol 20% | 50 | 80.1 | 23.0 | 12.2 | 31% |
| 172 | Water 100% | 0 | 80.0 | 22.9 | 9.3 | 0% |
| 173 | Water + ethanol 20% | 50 | 80.1 | 22.7 | 12.1 | 33% |
| 174 | Water 100% | 0 | 80.0 | 22.7 | 9.1 | 0% |
| 175 | Water + ethanol 20% | 50 | 80.2 | 23.1 | 12.0 | 35% |
| 176 | Water 100% | 0 | 80.3 | 23.0 | 8.9 | 0% |
| 177 | Water + ethanol 20% | 50 | 80.1 | 21.8 | 12.2 | 34% |
| 178 | Water 100% | 0 | 80.0 | 21.7 | 9.1 | 0% |
| 179 | Water + ethanol 20% | 55 | 80.3 | 23.3 | 12.2 | 33% |
| 180 | Water 100% | 0 | 80.2 | 23.2 | 9.2 | 0% |
| 181 | Water + ethanol 20% | 50 | 80.1 | 21.5 | 12.3 | 35% |
| 182 | Water 100% | 0 | 80.2 | 21.5 | 9.1 | 0% |
| 183 | Water + ethanol 20% | 50 | 80.4 | 23.3 | 12.0 | 35% |
| 184 | Water 100% | 0 | 80.1 | 23.2 | 8.9 | 0% |
| 185 | Water + ethanol 20% | 50 | 80.2 | 21.5 | 12.0 | 32% |
| 186 | Water 100% | 0 | 80.0 | 21.4 | 9.1 | 0% |

TABLE 16

| | | Soft magnetic powder | | |
|---|---|---|---|---|
| | | | | Average |
| | | | | particle |
| Sample | Example/ | Prepared composition | Analyzed composition | size |
| No. | Comparative Example | (wt %) | (wt %) | (μm) |
| 187 | Example | Fe_{90.6}Si_{6.4}Cr_{2.0}Ag_{1.0} | Fe_{90.4}Si_{6.4}Cr_{2.0}Ag_{1.0}C_{0.2} | 22.3 |
| 188 | Comparative Example | Fe_{90.4}Si_{6.4}Cr_{2.0}Ag_{1.0}C_{0.2} | Fe_{90.4}Si_{6.4}Cr_{2.0}Ag_{1.0}C_{0.2} | 22.5 |
| 189 | Example | Fe_{87.7}Si_{6.3}Cr_{2.0}Ag_{4.0} | Fe_{87.5}Si_{6.3}Cr_{2.0}Ag_{4.0}C_{0.2} | 22.2 |
| 190 | Comparative Example | Fe_{87.5}Si_{6.3}Cr_{2.0}Ag_{4.0}C_{0.2} | Fe_{87.5}Si_{6.3}Cr_{2.0}Ag_{4.0}C_{0.2} | 22.0 |
| 191 | Example | Fe_{90.9}Si_{6.4}Cr_{2.0}Zn_{0.6} | Fe_{90.7}Si_{6.4}Cr_{2.0}Zn_{0.6}C_{0.2} | 22.3 |
| 192 | Comparative Example | Fe_{90.7}Si_{6.4}Cr_{2.0}Zn_{0.6}C_{0.2} | Fe_{90.7}Si_{6.4}Cr_{2.0}Zn_{0.6}C_{0.2} | 22.4 |
| 193 | Example | Fe_{89.1}Si_{6.4}Cr_{2.0}Zn_{2.5} | Fe_{88.9}Si_{6.4}Cr_{2.0}Zn_{2.5}C_{0.2} | 22.1 |
| 194 | Comparative Example | Fe_{88.9}Si_{6.4}Cr_{2.0}Zn_{2.5}C_{0.2} | Fe_{88.9}Si_{6.4}Cr_{2.0}Zn_{2.5}C_{0.2} | 22.0 |
| 195 | Example | Fe_{90.9}Si_{6.4}Cr_{2.0}Sn_{1.1} | Fe_{90.3}Si_{6.4}Cr_{2.0}Sn_{1.1}C_{0.2} | 22.1 |
| 196 | Comparative Example | Fe_{90.3}Si_{6.4}Cr_{2.0}Sn_{1.1}C_{0.2} | Fe_{90.3}Si_{6.4}Cr_{2.0}Sn_{1.1}C_{0.2} | 22.5 |
| 197 | Example | Fe_{87.4}Si_{6.3}Cr_{1.9}Sn_{4.4} | Fe_{87.2}Si_{6.3}Cr_{1.9}Sn_{4.1}C_{0.2} | 22.4 |
| 198 | Comparative Example | Fe_{87.2}Si_{6.3}Cr_{1.9}Sn_{4.1}C_{0.2} | Fe_{87.2}Si_{6.3}Cr_{1.9}Sn_{4.1}C_{0.2} | 22.1 |
| 199 | Example | Fe_{90.9}Si_{6.4}Cr_{2.0}As_{0.7} | Fe_{90.7}Si_{6.4}Cr_{2.0}As_{0.7}C_{0.2} | 22.3 |
| 200 | Comparative Example | Fe_{90.7}Si_{6.4}Cr_{2.0}As_{0.7}C_{0.2} | Fe_{90.7}Si_{6.4}Cr_{2.0}As_{0.7}C_{0.2} | 22.5 |
| 201 | Example | Fe_{88.8}Si_{6.4}Cr_{2.0}As_{2.8} | Fe_{88.6}Si_{6.4}Cr_{2.0}As_{2.8}C_{0.2} | 22.3 |
| 202 | Comparative Example | Fe_{88.6}Si_{6.4}Cr_{2.0}As_{2.8}C_{0.2} | Fe_{88.6}Si_{6.4}Cr_{2.0}As_{2.8}C_{0.2} | 22.4 |
| 203 | Example | Fe_{90.5}Si_{6.4}Cr_{2.0}Sb_{1.1} | Fe_{90.3}Si_{6.4}Cr_{2.0}Sb_{1.1}C_{0.2} | 22.0 |
| 204 | Comparative Example | Fe_{90.3}Si_{6.4}Cr_{2.0}Sb_{1.1}C_{0.2} | Fe_{90.3}Si_{6.4}Cr_{2.0}Sb_{1.1}C_{0.2} | 22.1 |
| 205 | Example | Fe_{87.3}Si_{6.3}Cr_{1.9}Sb_{4.5} | Fe_{87.1}Si_{6.3}Cr_{1.9}Sb_{4.5}C_{0.2} | 22.5 |
| 206 | Comparative Example | Fe_{87.1}Si_{6.3}Cr_{1.9}Sb_{4.5}C_{0.2} | Fe_{87.1}Si_{6.3}Cr_{1.9}Sb_{4.5}C_{0.2} | 22.5 |

| | Soft magnetic powder | | Magnetic core | | | |
|---|---|---|---|---|---|---|
| | | Number ratio | | | DC superimposition | |
| | | of special | Packing | | characteristics | |
| | Atomization | soft magnetic | rate | Initial | | Isat |
| Sample | high-pressure | particles | η | permeability | Isat | improvement |
| No. | liquid | (%) | (%) | μ₀ | (A) | rate |
| 187 | Water + ethanol 20% | 50 | 80.2 | 23.5 | 12.3 | 32% |
| 188 | Water 100% | 0 | 80.1 | 23.4 | 9.3 | 0% |
| 189 | Water + ethanol 20% | 50 | 80.2 | 22.9 | 12.4 | 32% |
| 190 | Water 100% | 0 | 80.1 | 22.8 | 9.4 | 0% |
| 191 | Water + ethanol 20% | 50 | 80.2 | 23.2 | 12.4 | 33% |
| 192 | Water 100% | 0 | 80.1 | 23.3 | 9.3 | 0% |
| 193 | Water + ethanol 20% | 55 | 80.3 | 23.0 | 12.0 | 29% |
| 194 | Water 100% | 0 | 80.2 | 22.9 | 9.3 | 0% |
| 195 | Water + ethanol 20% | 50 | 80.1 | 23.1 | 12.3 | 32% |
| 196 | Water 100% | 0 | 80.3 | 23.1 | 9.3 | 0% |
| 197 | Water + ethanol 20% | 50 | 80.2 | 22.7 | 12.1 | 33% |
| 198 | Water 100% | 0 | 80.1 | 22.8 | 9.1 | 0% |
| 199 | Water + ethanol 20% | 50 | 80.2 | 23.3 | 12.4 | 35% |
| 200 | Water 100% | 0 | 80.1 | 23.1 | 9.2 | 0% |
| 201 | Water + ethanol 20% | 50 | 79.9 | 22.9 | 11.9 | 34% |
| 202 | Water 100% | 0 | 80.0 | 22.9 | 8.9 | 0% |
| 203 | Water + ethanol 20% | 50 | 80.1 | 23.1 | 12.2 | 33% |
| 204 | Water 100% | 0 | 80.2 | 23.2 | 9.2 | 0% |
| 205 | Water + ethanol 20% | 5 [symbol] | 80.2 | 23.0 | 12.3 | 35% |
| 206 | Water 100% | 0 | 80.5 | 22.9 | 9.1 | 0% |

[symbol]

indicates data missing or illegible when filed

TABLE 17

| | | Soft magnetic powder | | |
|---|---|---|---|---|
| | | | | Average |
| | | | | particle |
| Sample | Example/ | Prepared composition | Analyzed composition | size |
| No. | Comparative Example | (wt %) | (wt %) | (μm) |
| 207 | Example | Fe_{89.7}Si_{6.3}Cr_{3.0}Bi_{2.0} | Fe_{89.5}Si_{6.3}Cr_{3.0}Bi_{2.0}C_{0.2} | 22.4 |
| 208 | Comparative Example | Fe_{89.5}Si_{6.3}Cr_{3.0}Bi_{2.0}C_{0.2} | Fe_{89.5}Si_{6.3}Cr_{3.0}Bi_{2.0}C_{0.2} | 22.5 |
| 209 | Example | Fe_{84.5}Si_{6.1}Cr_{1.9}Bi_{7.5} | Fe_{84.3}Si_{6.1}Cr_{1.9}Bi_{7.5}C_{0.2} | 22.2 |
| 210 | Comparative Example | Fe_{84.3}Si_{6.1}Cr_{1.9}Bi_{7.5}C_{0.2} | Fe_{84.3}Si_{6.1}Cr_{1.9}Bi_{7.5}C_{0.2} | 22.1 |
| 211 | Example | Fe_{91.6}Si_{6.4}Cr_{2.0}N_{0.001} | Fe_{91.4}Si_{6.4}Cr_{2.0}N_{0.001}C_{0.2} | 22.3 |
| 212 | Comparative Example | Fe_{91.4}Si_{6.4}Cr_{2.0}N_{0.001}C_{0.2} | Fe_{91.4}Si_{6.4}Cr_{2.0}N_{0.001}C_{0.2} | 22.4 |
| 213 | Example | Fe_{91.6}Si_{6.4}Cr_{2.0}N_{0.005} | Fe_{91.4}Si_{6.4}Cr_{2.0}N_{0.005}C_{0.2} | 22.3 |
| 214 | Comparative Example | Fe_{91.4}Si_{6.4}Cr_{2.0}N_{0.005}C_{0.2} | Fe_{91.4}Si_{6.4}Cr_{2.0}N_{0.005}C_{0.2} | 22.1 |
| 215 | Example | Fe_{91.6}Si_{6.4}Cr_{2.0}O_{0.015} | Fe_{91.4}Si_{6.4}Cr_{2.0}O_{0.015}C_{0.2} | 22.0 |
| 216 | Comparative Example | Fe_{91.4}Si_{6.4}Cr_{2.0}O_{0.015}C_{0.2} | Fe_{91.4}Si_{6.4}Cr_{2.0}O_{0.015}C_{0.2} | 21.9 |
| 217 | Example | Fe_{91.5}Si_{6.4}Cr_{2.0}O_{0.006} | Fe_{91.3}Si_{6.4}Cr_{2.0}O_{0.006}C_{0.2} | 22.0 |
| 218 | Comparative Example | Fe_{91.3}Si_{6.4}Cr_{2.0}O_{0.006}C_{0.2} | Fe_{91.3}Si_{6.4}Cr_{2.0}O_{0.006}C_{0.2} | 22.1 |
| 219 | Example | Fe_{90.4}Si_{6.1}B_{3.5} | Fe_{90.2}Si_{6.1}B_{2.5}C_{0.2} | 22.5 |
| 220 | Comparative Example | Fe_{90.2}Si_{6.1}B_{2.5}C_{0.2} | Fe_{90.2}Si_{6.1}B_{2.5}C_{0.2} | 22.4 |
| 221 | Example | Fe_{90.6}Si_{6.6}B_{2.5}C_{0.3} | Fe_{90.4}Si_{6.6}B_{2.5}C_{0.5} | 22.1 |
| 222 | Comparative Example | Fe_{90.4}Si_{6.6}B_{2.5}C_{0.5} | Fe_{90.4}Si_{6.6}B_{2.5}C_{0.5} | 22.4 |
| 223 | Example | Fe_{89.4}Si_{6.6}B_{2.5}Cr_{1.1}C_{0.3} | Fe_{89.2}Si_{6.1}B_{2.5}Cr_{1.1}C_{0.5} | 22.2 |
| 224 | Comparative Example | Fe_{89.2}Si_{6.1}B_{2.5}Cr_{1.1}C_{0.5} | Fe_{89.2}Si_{6.1}B_{2.5}Cr_{1.1}C_{0.5} | 22.1 |
| 225 | Example | Fe_{83.0}Si_{8.0}Nb_{5.7}B_{2.0}Cu_{1.3} | Fe_{82.8}Si_{8.0}Nb_{5.7}B_{2.0}Cu_{1.3}C_{0.2} | 22.2 |
| 226 | Comparative Example | Fe_{82.8}Si_{8.0}Nb_{5.7}B_{2.0}Cu_{1.3}C_{0.2} | Fe_{82.8}Si_{8.0}Nb_{5.7}B_{2.0}Cu_{1.3}C_{0.2} | 32.0 |
| 227 | Example | Fe_{82.4}Si_{1.1}B_{1.8}P_{2.3}Nb_{12.2} | Fe_{82.2}Si_{1.1}B_{1.8}P_{2.3}Nb_{12.3}C_{0.2} | 22.1 |
| 228 | Comparative Example | Fe_{82.2}Si_{1.1}B_{1.8}P_{2.3}Nb_{12.3}C_{0.2} | Fe_{82.2}Si_{1.1}B_{1.8}P_{2.3}Nb_{12.3}C_{0.2} | 22.0 |

| | Soft magnetic powder | | Magnetic core | | | |
|---|---|---|---|---|---|---|
| | | Number ratio | | | DC superimposition | |
| | | of special | Packing | | characteristics | |
| | Atomization | soft magnetic | rate | Initial | | Isat |
| Sample | high-pressure | particles | η | permeability | Isat | improvement |
| No. | liquid | (%) | (%) | μ₀ | (A) | rate |
| 207 | Water + ethanol 20% | 55 | 80.1 | 23.1 | 12.2 | 34% |
| 208 | Water 100% | 0 | 80.3 | 23.0 | 9.1 | 0% |
| 205 | Water + ethanol 20% | 50 | 80.1 | 21.1 | 12.0 | 33% |
| 210 | Water 100% | 0 | 80.0 | 21.2 | 9.0 | 0% |
| 211 | Water + ethanol 20% | 50 | 80.3 | 23.5 | 12.1 | 34% |
| 212 | Water 100% | 0 | 80.1 | 23.4 | 9.0 | 0% |
| 213 | Water + ethanol 20% | 50 | 8.1 | 23.3 | 12.0 | 32% |
| 214 | Water 100% | 0 | 80.2 | 23.4 | 9.1 | 0% |
| 215 | Water + ethanol 20% | 50 | 80.4 | 23.4 | 12.1 | 34% |
| 216 | Water 100% | 0 | 80.5 | 23.3 | 9.0 | 0% |
| 217 | Water + ethanol 20% | 50 | 80.1 | 23.2 | 12.2 | 34% |
| 218 | Water 100% | 0 | 80.4 | 23.3 | 9.1 | 0% |
| 219 | Water + ethanol 20% | 50 | 80.5 | 23.1 | 12.2 | 34% |
| 220 | Water 100% | 0 | 80.2 | 23.0 | 9.1 | 0% |
| 221 | Water + ethanol 20% | 50 | 80.0 | 23.0 | 12.3 | 34% |
| 222 | Water 100% | 0 | 80.2 | 23.1 | 9.2 | 0% |
| 223 | Water + ethanol 20% | 50 | 80.5 | 22.9 | 12.2 | 33% |
| 224 | Water 100% | 0 | 80.2 | 22.9 | 9.2 | 0% |
| 225 | Water + ethanol 20% | 55 | 80.1 | 20.2 | 12.3 | 31% |
| 226 | Water 100% | 0 | 80.0 | 20.2 | 9.4 | 0% |
| 227 | Water + ethanol 20% | 60 | 80.2 | 20.1 | 11.9 | 31% |
| 228 | Water 100% | 0 | 80.2 | 20.1 | 9.1 | 0% |

TABLE 18

| | | [symbol] magnetic powder | | |
|---|---|---|---|---|
| | | | | Average |
| | | | | particle |
| Sample | Example/ | Prepared composition | Analyzed composition | size |
| No. | Comparative Example | (wt %) | (wt %) | (μm) |
| 229 | Example | (Fe_{0.9}C_{0.1})_{88.0}Si_{12.0} | (Fe_{0.9}C_{0.1})_{87.3}Si_{12.0}C_{0.2} | 22.5 |
| 230 | Comparative Example | (Fe_{0.9}C_{0.1})_{87.3}Si_{12.0}C_{0.2} | (Fe_{0.9}C_{0.1})_{87.3}Si_{12.0}C_{0.2} | 22.3 |
| 231 | Example | (Fe_{0.9}C_{0.1})_{93.5}Si_{6.4}C_{0.1} | (Fe_{0.9}C_{0.1})₉ [symbol] _{.3}Si_{6.4}C_{0.3} | 22.1 |
| 232 | Comparative Example | (Fe_{0.9}C_{0.1})₉ [symbol] _{.3}Si_{6.4}C_{0.3} | (Fe_{0.9}C_{0.1})₉ [symbol] _{.3}Si_{6.4}C_{0.3} | 22.1 |
| 233 | Example | (Fe_{0.9}C_{0.1})_{93.3}Si_{6.4}C_{0.3} | (Fe_{0.9}C_{0.1})_{93.1}Si_{6.4}C_{0.5} | 22.4 |
| 234 | Comparative Example | (Fe_{0.9}C_{0.1})_{93.1}Si_{6.4}C_{0.5} | (Fe_{0.9}C_{0.1})_{93.1}Si_{6.4}C_{0.5} | 22.5 |
| 235 | Example | (Fe_{0.9}C_{0.1})_{93.3}Si_{6.4}Al_{0.3} | (Fe_{0.9}C_{0.1})_{93.1}Si_{6.4}Al_{0.3}C_{0.3} | 22.1 |
| 236 | Comparative Example | (Fe_{0.9}C_{0.1})_{93.1}Si_{6.4}Al_{0.3}C_{0.3} | (Fe_{0.9}C_{0.1})_{93.1}Si_{6.4}Al_{0.3}C_{0.3} | 22.2 |
| 237 | Example | (Fe_{0.9}C_{0.1})_{92.5}Si_{6.5}Al_{1.0} | (Fe_{0.9}C_{0.1})_{92.3}Si_{6.5}Al_{1.0}C_{0.2} | 22.4 |
| 238 | Comparative Example | (Fe_{0.9}C_{0.1})_{92.3}Si_{6.5}Al_{1.0}C_{0.2} | (Fe_{0.9}C_{0.1})_{92.3}Si_{6.5}Al_{1.0}C_{0.2} | 22.2 |
| 239 | Example | (Fe_{0.9}C_{0.1})_{93.6}Si_{6.4}S_{0.015} | (Fe_{0.9}C_{0.1})_{93.4}Si_{6.4}S_{0.015}C_{0.2} | 22.1 |
| 240 | Comparative Example | (Fe_{0.9}C_{0.1})_{93.4}Si_{6.4}S_{0.015}C_{0.2} | (Fe_{0.9}C_{0.1})_{93.4}Si_{6.4}S_{0.015}C_{0.2} | 22.5 |
| 241 | Example | (Fe_{0.9}C_{0.1})_{93.6}Si_{6.4}S_{0.061} | (Fe_{0.9}C_{0.1})_{93.4}Si_{6.4}S_{0.061}C_{0.2} | 22.3 |
| 242 | Comparative Example | (Fe_{0.9}C_{0.1})_{93.4}Si_{6.4}S_{0.061}C_{0.2} | (Fe_{0.9}C_{0.1})_{93.4}Si_{6.4}S_{0.061}C_{0.2} | 22.3 |

| | [symbol] magnetic powder | | Magnetic core | | | |
|---|---|---|---|---|---|---|
| | | Number ratio | | | DC superimposition | |
| | | of special | Packing | | characteristics | |
| | Atomization | soft magnetic | rate | Initial | | Isat |
| Sample | high-pressure | particles | η | permeability | Isat | improvement |
| No. | liquid | (%) | (%) | μ₀ | (A) | rate |
| 229 | Water + ethanol 20% | 50 | 80.0 | 23.2 | 12.2 | 33% |
| 230 | Water 100% | 0 | 79.9 | 23.1 | 9.2 | 0% |
| 231 | Water + ethanol 20% | 50 | 80.1 | 25.3 | 12.3 | 32% |
| 232 | Water 100% | 0 | 80.2 | 25.2 | 9.3 | 0% |
| 233 | Water + ethanol 20% | 50 | 80.0 | 25.4 | 12.4 | 32% |
| 234 | Water 100% | 0 | 80.4 | 25.4 | 9.4 | 0% |
| 235 | Water + ethanol 20% | 50 | 80.1 | 25.3 | 12.3 | 34% |
| 236 | Water 100% | 0 | 80.1 | 25.1 | 9.2 | 0% |
| 237 | Water + ethanol 20% | 55 | 8.0 | 25.2 | 12.1 | 30% |
| 238 | Water 100% | 0 | 80.2 | 25.0 | 9.3 | 0% |
| 239 | Wafer + ethanol 20% | 50 | 80.3 | 25.2 | 12.2 | 33% |
| 240 | Water 100% | 0 | 80.1 | 25.3 | 9.2 | 0% |
| 241 | Water + ethanol 20% | 50 | 80.0 | 25.4 | 12.1 | 33% |
| 242 | Water 100% | 0 | 79.9 | 25.4 | 9.1 | 0% |

[symbol]

indicates data missing or illegible when filed

TABLE 19

| | | So [symbol] magnetic powder | | |
|---|---|---|---|---|
| | | | | Average |
| | | | | particle |
| Sample | Example/ | Prepared composition | Analyzed composition | size |
| No. | Comparative Example | (wt %) | (wt %) | (μm) |
| 243 | Example | (Fe_{0.9}C_{0.1})_{93.2}Si_{6.4}Ti_{0.4} | (Fe_{0.9}C_{0.1})_{93.0}Si_{6.4}Ti_{0.4}C_{0.2} | 22.1 |
| 244 | Comparative Example | (Fe_{0.9}C_{0.1})_{93.0}Si_{6.4}Ti_{0.4}C_{0.2} | (Fe_{0.9}C_{0.1})_{93.0}Si_{6.4}Ti_{0.4}C_{0.2} | 22.0 |
| 245 | Example | (Fe_{0.9}C_{0.1})_{91.3}Si_{6.4}Ti_{1.8} | (Fe_{0.9}C_{0.1})_{91.6}Si_{6.4}Ti_{1.8}C_{0.2} | 22.1 |
| 246 | Comparative Example | (Fe_{0.9}C_{0.1})_{91.6}Si_{6.4}Ti_{1.8}C_{0.2} | (Fe_{0.9}C_{0.1})_{91.6}Si_{6.4}Ti_{1.8}C_{0.2} | 22.2 |
| 247 | Example | (Fe_{0.9}C_{0.1})_{93.1}Si_{6.4}V_{0.5} | (Fe_{0.9}C_{0.1})_{93.9}Si_{6.4}V_{0.5}C_{0.2} | 22.4 |
| 248 | Comparative Example | (Fe_{0.9}C_{0.1})_{93.9}Si_{6.4}V_{0.5}C_{0.2} | (Fe_{0.9}C_{0.1})_{93.9}Si_{6.4}V_{0.5}C_{0.2} | 22.3 |
| 249 | Example | (Fe_{0.9}C_{0.1})_{91.7}Si_{6.4}V_{1.9} | (Fe_{0.9}C_{0.1})_{91.5}Si_{6.4}V_{1.9}C_{0.2} | 22.1 |
| 250 | Comparative Example | (Fe_{0.9}C_{0.1})_{91.5}Si_{6.4}V_{1.9}C_{0.2} | (Fe_{0.9}C_{0.1})_{91.5}Si_{6.4}V_{1.9}C_{0.2} | 22.3 |
| 251 | Example | (Fe_{0.9}C_{0.1})_{93.1}Si_{6.4}Mn_{0.5} | (Fe_{0.9}C_{0.1})_{92.9}Si_{6.4}Mn_{0.5}C_{0.2} | 22.1 |
| 252 | Comparative Example | (Fe_{0.9}C_{0.1})_{92.9}Si_{6.4}Mn_{0.5}C_{0.2} | (Fe_{0.9}C_{0.1})_{92.9}Si_{6.4}Mn_{0.5}C_{0.2} | 22.4 |
| 253 | Example | (Fe_{0.9}C_{0.1})_{91.} [symbol] Si_{6.4}Mn_{2.1} | (Fe_{0.9}C_{0.1})_{91.3}Si_{6.4}Mn_{2.1}C_{0.2} | 22.3 |
| 254 | Comparative Example | (Fe_{0.9}C_{0.1})_{91.3}Si_{6.4}Mn_{2.1}C_{0.2} | (Fe_{0.9}C_{0.1})_{91.3}Si_{6.4}Mn_{2.1}C_{0.2} | 22.5 |
| 255 | Example | (Fe_{0.9}C_{0.1})_{93.} [symbol] Si_{6.4}Ni_{0.6} | (Fe_{0.9}C_{0.1})_{92.8}Si_{6.4}Ni_{0.6}C_{0.2} | 22.1 |
| 256 | Comparative Example | (Fe_{0.9}C_{0.1})_{92.8}Si_{6.4}Ni_{0.6}C_{0.2} | (Fe_{0.9}C_{0.1})_{92.8}Si_{6.4}Ni_{0.6}C_{0.2} | 22.3 |
| 257 | Example | (Fe_{0.9}C_{0.1})_{91.4}Si_{6.4}Ni_{2.2} | (Fe_{0.9}C_{0.1})_{91.2}Si_{6.4}Ni_{2.2}C_{0.2} | 22.2 |
| 258 | Comparative Example | (Fe_{0.9}C_{0.1})_{91.2}Si_{6.4}Ni_{2.2}C_{0.2} | (Fe_{0.9}C_{0.1})_{91.2}Si_{6.4}Ni_{2.2}C_{0.2} | 22.0 |
| 259 | Example | (Fe_{0.9}C_{0.1})₉ [symbol] _{.0}Si_{6.4}Cu_{0.6} | (Fe_{0.9}C_{0.1})_{92.8}Si_{6.4}Cu_{0.6}C_{0.2} | 22.4 |
| 260 | Comparative Example | (Fe_{0.9}C_{0.1})_{92.8}Si_{6.4}Cu_{0.6}C_{0.2} | (Fe_{0.9}C_{0.1})_{92.8}Si_{6.4}Cu_{0.6}C_{0.2} | 22.3 |
| 261 | Example | (Fe_{0.9}C_{0.1})_{91.2}Si_{6.4}Cu_{2.4} | (Fe_{0.9}C_{0.1})_{91.0}Si_{6.4}Cu_{2.4}C_{0.2} | 22.3 |
| 262 | Comparative Example | (Fe_{0.9}C_{0.1})_{91.0}Si_{6.4}Cu_{2.4}C_{0.2} | (Fe_{0.9}C_{0.1})_{91.0}Si_{6.4}Cu_{2.4}C_{0.2} | 21.9 |

| | So [symbol] magnetic powder | | Magnetic core | | | |
|---|---|---|---|---|---|---|
| | | Number ratio | | | DC superimposition | |
| | | of special | Packing | | characteristics | |
| | Atomization | soft magnetic | rate | Initial | | Isat |
| Sample | high-pressure | particles | η | permeability | Isat | improvement |
| No. | liquid | (%) | (%) | μ₀ | (A) | rate |
| 243 | Water + ethanol 20% | 50 | 80.1 | 23.3 | 12.2 | 33% |
| 244 | Water 100% | 0 | 80.4 | 25.4 | 9.2 | 0% |
| 245 | Water + ethanol 20% | 55 | 80.1 | 23.8 | 12.3 | 31% |
| 246 | Water 100% | 0 | 80.5 | 23.7 | 9.4 | 0% |
| 247 | Water + ethanol 20% | 50 | 80.1 | 25.0 | 12.3 | 32% |
| 248 | Water 100% | 0 | 80.0 | 24.8 | 9.3 | 0% |
| 249 | Water + ethanol 20% | 50 | 80.1 | 23.9 | 12.4 | 32% |
| 250 | Water 100% | 0 | 80.2 | 23.8 | 9.4 | 0% |
| 251 | Water + ethanol 20% | 50 | 80.2 | 24.7 | 12.1 | 32% |
| 252 | Water 100% | 0 | 80.3 | 24.2 | 9.2 | 0% |
| 253 | Water + ethanol 20% | 55 | 80.3 | 24.0 | 12.1 | 33% |
| 254 | Water 100% | 0 | 80.1 | 23.8 | 9.1 | 0% |
| 255 | Water + ethanol 20% | 50 | 80.0 | 24.1 | 12.2 | 33% |
| 256 | Water 100% | 0 | 80.1 | 24.2 | 9.2 | 0% |
| 257 | Water + ethanol 20% | 50 | 80.2 | 23.8 | 12.0 | 33% |
| 258 | Water 100% | 0 | 80.3 | 23.7 | 9.0 | 0% |
| 259 | Water + ethanol 20% | 50 | 80.1 | 24.5 | 12.2 | 34% |
| 260 | Water 100% | 0 | 80.2 | 24.6 | 9.1 | 0% |
| 261 | Water + ethanol 20% | 50 | 80.1 | 23.9 | 12.3 | 34% |
| 262 | Water 100% | 0 | 80.4 | 23.7 | 9.2 | 0% |

[symbol]

indicates data missing or illegible when filed

TABLE 20

| | | Soft magnetic powder | | |
|---|---|---|---|---|
| | | | | Average |
| | | | | particle |
| Sample | Example/ | Prepared composition | Analyzed composition | size |
| No. | Comparative Example | (wt %) | (wt %) | (μm) |
| 253 | Example | (Fe_{0.8}Co_{0.2})_{92.8}P_{2.5}B_{2.4}Si_{1.1}Cr_{1.0} | (Fe_{0.8}Co_{0.2})_{93.0}P_{2.5}B_{2.4}Si_{1.1}Cr_{1.0}C_{0.2} | 22.4 |
| 254 | Comparative Example | (Fe_{0.8}Co_{0.2})_{92.8}P_{2.5}B_{2.4}Si_{1.1}Cr_{1.0}C_{0.2} | (Fe_{0.8}Co_{0.2})_{92.8}P_{2.5}B_{2.4}Si_{1.1}Cr_{1.0}C_{0.2} | 22.0 |
| 265 | Example | (Fe_{0.7}Co_{0.3})_{94.6}P_{2.5}B_{2.5}Si_{0.} [symbol] C_{0.1} | (Fe_{0.7}Co_{0.3})_{94.4}P_{2.5}B_{2.5}Si_{0.3}C_{0.3} | 22.2 |
| 266 | Comparative Example | (Fe_{0.7}Co_{0.3})_{94.4}P_{2.5}B_{2.5}Si_{0.3}C_{0.3} | (Fe_{0.7}Co_{0.3})_{94.4}P_{2.5}B_{2.5}Si_{0.3}C_{0.3} | 22.1 |
| 267 | Example | (Fe_{0.8}Co_{0.2})_{89.6}P_{9.2}C_{1.2} | (Fe_{0.8}Co_{0.2})_{89.4}P_{9.2}C_{1.4} | 22.2 |
| 258 | Comparative Example | (Fe_{0.8}Co_{0.2})_{89.4}P_{9.2}C_{1.4} | (Fe_{0.8}Co_{0.2})_{89.4}P_{9.2}C_{1.4} | 22.6 |
| 269 | Example | (Fe_{0.75}Co_{0.25})_{95.4}B_{4.6} | (Fe_{0.75}Co_{0.25})_{95.2}B_{4.6}C_{0.2} | 22.4 |
| 270 | Comparative Example | (Fe_{0.75}Co_{0.25})_{95.2}B_{4.6}C_{0.2} | (Fe_{0.75}Co_{0.25})_{95.2}B_{4.6}C_{0.2} | 22.3 |
| 271 | Example | (Fe_{0.8}Co_{0.2})_{90.5}Si_{6.0}B_{3.5} | (Fe_{0.8}Co_{0.2})_{90.3}Si_{6.0}B_{3.5}C_{0.2} | 22.5 |
| 272 | Comparative Example | (Fe_{0.8}Co_{0.2})_{90.3}Si_{6.0}B_{3.5}C_{0.2} | (Fe_{0.8}Co_{0.2})_{90.3}Si_{6.0}B_{3.5}C_{0.2} | 22.5 |
| 273 | Example | (Fe_{0.75}Co_{0.25})_{79.4}Nb_{13.2}Mo_{5.1}B_{1.7}P_{0.6} | (Fe_{0.75}Co_{0.25})_{79.2}Nb_{13.2}Mo_{5.1}B_{1.7}P_{0.6}C_{0.2} | 22.1 |
| 274 | Comparative Example | (Fe_{0.75}Co_{0.25})_{79.2}Nb_{13.2}Mo_{5.1}B_{1.7}P [symbol] _{.6}C_{0.2} | (Fe_{0.75}Co_{0.25})_{79.2}Nb_{13.2}Mo_{5.1}B_{1.7}P_{0.6}C_{0.2} | 22.0 |
| 275 | Example | (Fe_{0.75}Co_{0.25})_{82.6}Nb_{8.6}Zr_{5.1}B_{2.0}P_{1.7} | (Fe_{0.75}Co_{0.25})_{82.4}Nb_{8.5}Zr_{5.1}B_{2.0}P_{1.7}C_{0.2} | 22.4 |
| 276 | Comparative Example | (Fe_{0.75}Co_{0.25})_{82.4}Nb_{8.6}Zr_{5.1}B_{2.0}P_{1.7}C_{0.2} | (Fe_{0.75}Co_{0.25})_{82.4}Nb_{8.5}Zr_{5.1}B_{2.0}P_{1.7}C_{0.2} | 22.3 |
| 277 | Example | (Fe_{0.75}Co_{0.25})_{83.1}Zr_{13.1}Mo_{1.7}B_{1.5}P_{0.6} | (Fe_{0.75}Co_{0.25})_{82.9}Zr_{13.1}Mo_{1.7}B_{1.5}P_{0.6}C_{0.2} | 22.3 |
| 278 | Comparative Example | (Fe_{0.75}Co_{0.25})_{82.9}Zr_{13.1}Mo_{1.7}B_{1.5}P_{0.6}C_{0.2} | (Fe_{0.75}Co_{0.25})_{82.9}Zr_{13.1}Mo_{1.7}B_{1.5}P_{0.6}C_{0.2} | 22.5 |

| | Soft magnetic powder | | Magnetic core | | | |
|---|---|---|---|---|---|---|
| | | Number ratio | | | DC superimposition | |
| | | of special | Packing | | characteristics | |
| | Atomization | soft magnetic | rate | Initial | | Isat |
| Sample | high-pressure | particles | η | permeability | Isat | improvement |
| No. | liquid | (%) | (%) | μ₀ | (A) | rate |
| 253 | Water + ethanol 20% | 50 | 80.3 | 24.3 | 12.2 | 34% |
| 254 | Water 100% | 0 | 80.2 | 24.4 | 9.1 | 0% |
| 265 | Water + ethanol 20% | 50 | 80.4 | 26.9 | 12.2 | 30% |
| 266 | Water 100% | 0 | 80.2 | 26.5 | 9.0 | 0% |
| 267 | Water + ethanol 20% | 55 | 80.1 | 23.0 | 12.2 | 34% |
| 258 | Water 100% | 0 | 80.0 | 23.1 | 9.1 | 0% |
| 269 | Water + ethanol 20% | 50 | 80.3 | 28.6 | 12.4 | 32% |
| 270 | Water 100% | 0 | 80.2 | 28.4 | 9.4 | 0% |
| 271 | Water + ethanol 20% | 50 | 80.1 | 24.0 | 12.3 | 37% |
| 272 | Water 100% | 0 | 80.3 | 24.1 | 9.0 | 0% |
| 273 | Water + ethanol 20% | 55 | 80.1 | 20.3 | 12.2 | 39% |
| 274 | Water 100% | 0 | 80.3 | 20.4 | 8.8 | 0% |
| 275 | Water + ethanol 20% | 50 | 80.1 | 20.9 | 12.4 | 41% |
| 276 | Water 100% | 0 | 80.2 | 21.0 | 8.8 | 0% |
| 277 | Water + ethanol 20% | 50 | 80.2 | 21.1 | 12.4 | 3 [symbol] % |
| 278 | Water 100% | 0 | 80.3 | 21.2 | 8.9 | 0% |

[symbol]

indicates data missing or illegible when filed

According to the tables, regardless of the compositions of the soft magnetic powders being changed within the predetermined range, the magnetic cores including the soft magnetic powders including the specific soft magnetic particles had high μ₀ and had improved DC superimposition characteristics compared to the magnetic cores including the soft magnetic powders not including the specific soft magnetic particles.

1. A soft magnetic powder comprising Fe and C, wherein
the soft magnetic powder has a C content of 0.01 mass % or more and 0.5 mass % or less;
the soft magnetic powder comprises a specific soft magnetic particle; and
the specific soft magnetic particle comprises both a phase having a symmetry of a space group Im-3m or Pm-3m and a phase having a symmetry of a space group Pnam.

2. The soft magnetic powder according to claim 1, wherein
the soft magnetic powder further comprises Co; and
the soft magnetic powder has a ratio of an Fe content to a total content of Fe and Co of 25 mass % or more and 99 mass % or less.

3. The soft magnetic powder according to claim 2, wherein
the phase having the symmetry of the space group Im-3m or Pm-3m comprises an (Fe, Co) phase; and
the phase having the symmetry of the space group Pnam comprises an (Fe, Co)₃C phase.

4. The soft magnetic powder according to claim 1, wherein the specific soft magnetic particle comprising specific soft magnetic particles accounts for a number ratio of 10% or more.

5. The soft magnetic powder according to claim 1, wherein soft magnetic particles included in the soft magnetic powder have an average particle size of 0.1 μm or more and 50 μm or less.

6. The soft magnetic powder according to claim 1, wherein
the soft magnetic powder further comprises a subcomponent; and
the soft magnetic powder has a content of the subcomponent of 15 mass % or less out of 100 mass % of the soft magnetic powder.

7. The soft magnetic powder according to claim 6, wherein the subcomponent comprises at least one selected from the group consisting of B, Si, P, Cu, V, Ti, Zr, Hf, Nb, Ta, Mo, W, Cr, Ni, Al, Mn, Ag, Zn, S, Sn, As, Sb, Bi, N, O, and a rare earth element.

8. A magnetic core comprising the soft magnetic powder according to claim 1.

9. A magnetic device comprising the soft magnetic powder according to claim 1.
